(19) United States
(12) Patent Application Publication
(10) Pub. No.: US 2017/0178664 A1
(43) Pub. Date: Jun. 22, 2017

(54) APPARATUS, SYSTEMS AND METHODS FOR PROVIDING CLOUD BASED BLIND SOURCE SEPARATION SERVICES

(71) Applicant: ANALOG DEVICES, INC., NORWOOD, MA (US)

(72) Inventors: DAVID WINGATE, ASHLAND, MA (US); BENJAMIN VIGODA, WINCHESTER, MA (US); PATRICK OHIOMOBA, BOSTON, MA (US); BRIAN DONNELLY, SUDBURY, MA (US); NOAH DANIEL STEIN, SOMERVILLE, MA (US)

(73) Assignee: ANALOG DEVICES, INC., NORWOOD, MA (US)

(21) Appl. No.: 15/129,802

(22) PCT Filed: Mar. 26, 2015
(86) PCT No.: PCT/US2015/022822

§ 371 Date: Sep. 27, 2016

Related U.S. Application Data
(60) Provisional application No. 61/978,707, filed on Apr. 11, 2014.

(51) Int. Cl. G10L 21/0308; G10L 25/30; G10L 21/0232

(52) U.S. Cl. CPC G10L 21/0308; G10L 21/0232; G10L 25/30; G10L 2021/02166

(57) ABSTRACT

Use of spoken input for user devices, e.g. smartphones, can be challenging due to presence of other sound sources. Blind source separation (BSS) techniques aim to separate a sound generated by a particular source of interest from a mixture of different sounds. Various BSS techniques disclosed herein are based on recognition that providing additional information that is considered within iterations of a nonnegative tensor factorization (NTF) model improves accuracy and efficiency of source separation. Examples of such information include direction estimates or neural network models trained to recognize a particular sound of interest. Furthermore, identifying and processing incremental changes to an NTF model, rather than re-processing the entire model each time data changes, provides an efficient and fast manner for performing source separation on large sets of quickly changing data. Carrying out at least parts of BSS techniques in a cloud allows flexible utilization of local and remote sources.

### CROSS-REFERENCE TO RELATED APPLICATION

This application claims the benefit of and priority to U.S. Provisional Patent Application No. 61/978,707 filed 11 Apr. 2014 entitled “APPARATUS, SYSTEMS, AND METHODS FOR PROVIDING CLOUD BASED BLIND SOURCE SEPARATION SERVICES”, which is incorporated herein by reference in its entirety.

### TECHNICAL FIELD OF THE DISCLOSURE

The present disclosure relates to apparatus, systems, and methods for providing blind source separation services.

### BACKGROUND

Use of spoken input for user devices, including smartphones, automobiles, etc., can be challenging due to the acoustic environment in which a desired signal from a speaker is acquired. One broad approach to separating a signal from a source of interest using multiple microphone signals is beamforming, which uses multiple microphones separated by distances on the order of a wavelength or more to provide directional sensitivity to the microphone system. However, beamforming approaches may be limited, for example, by inadequate separation of the microphones.

A number of techniques have been developed for source separation from a single microphone signal, including techniques that make use of time versus frequency decompositions. A process of performing the source separation without any prior information about the acoustic signals is often referred to as “blind source separation” (BSS). Some BSS techniques make use of Non-Negative Matrix Factorization (NMF). Some BSS techniques have been applied to situations in which multiple microphone signals are available, for example, with widely spaced microphones.

### OVERVIEW

Various aspects of the present disclosure relate to different BSS techniques and are described in the following context, unless specified otherwise.

There is at least one acoustic sensor configured to acquire an acoustic signal. The signal typically has contributions from a plurality of different acoustic sources, where, as used herein, the term “contribution of an acoustic source” refers to at least a portion of an acoustic signal generated by the acoustic source, typically the portion being a portion of a particular frequency or a range of frequencies, at a particular time or range of times. When an acoustic source is e.g. a person speaking, there will be multiple contributions, i.e. there will be acoustic signals of different frequencies at different times generated by such a “source.”

In some embodiments a plurality of acoustic sensors, arranged e.g. in a sensor array, are configured to acquire such signals (i.e., each acoustic sensor acquires a corresponding signal). In some embodiments where a plurality of acoustic sensors are employed, the sensors may be provided relatively close to one another, e.g. less than 2 centimeters (cm) apart, preferably less than 1 cm apart. In an embodiment, the sensors may be arranged separated by distances that are much smaller, on the order of e.g. 1 millimeter (mm) or about 300 times than typical sound wavelength, where beamforming techniques, used e.g. for determining direction of arrival (DOA) of an acoustic signal, do not apply. While some embodiments where a plurality of acoustic sensors are employed make a distinction between the signals acquired by different sensors (e.g. for the purpose of determining DOA by e.g. comparing the phases of the different signals), other embodiments may consider the plurality of signals acquired by an array of acoustic sensors as a single signal, possibly by combining the individual acquired signals into a single signal as is appropriate for a particular implementation. Therefore, in the following, when an “acquired signal” is discussed in a singular form, then, unless otherwise specified, it is to be understood that the signal may comprise several acquired signals acquired by different sensors.

The different BSS techniques presented herein are based on computing time-dependent spectral characteristics X of the acquired signal. A characteristic could e.g. be a quantity indicative of a magnitude of the acquired signal. A characteristic is “spectral” in that it is computed for a particular frequency or a range of frequencies. A characteristic is “time-dependent” in that it may have different values at different times.

In an embodiment, such characteristics may be a Short Time Fourier Transform (STFT), computed as follows. An acquired signal is functionally divided into overlapping blocks, referred to herein as “frames.” For example, frames may be of a duration of 64 milliseconds (ms) and be overlapping by e.g. 48 ms. The portion of the acquired signal within a frame is then multiplied with a window function (i.e. a window function is applied to the frames) to smooth the edges. As is known in signal processing, and in particular in spectral analysis, the term “window function” (also known as tapering or apodization function) refers to a mathematical function that has values equal to or close to zero outside of a particular interval. The values outside the interval do not have to be identically zero, as long as the product of the window multiplied by its argument is square integrable, and, more specifically, that the function goes sufficiently rapidly toward zero. In typical applications, the window functions used are non-negative smooth “bell-shaped” curves, though rectangle, triangle, and other functions can be used. For instance, a function that is constant inside the interval and zero elsewhere is called a “rectangular window,” referring to the shape of its graphical representation. Next, a transformation function, such as e.g. Fast Fourier Transform (FFT), is applied transforming the waveform multiplied by the window function from a time domain to a frequency domain. As a result, a frequency decomposition of a portion of the acquired signal within each frame is obtained. The frequency decomposition of all of the frames may be arranged in a matrix where frames and frequency are indexed (in the following, frames are described to be indexed by “n” and frequencies are described to be indexed by “f”). Each element of such an array, indexed by (f,n) comprises a complex value resulting from the application of the transformation function and is referred to herein as a “time-frequency bin” or simply “bin.” The term “bin” may be viewed as indicative of the fact that such a matrix may be considered as comprising a plurality of bins into which the signal's energy is distributed. In an embodiment, the bins may be considered to contain not complex values but positive real quantities X(f,n) of the complex values, such quantities representing magnitudes of the acquired signal, presented e.g. as an actual magnitude, a squared magnitude, or as a compressive transformation of a magnitude, such as a square root.

Time-frequency bins come into play in BSS algorithms in that separation of a particular acoustic signal of interest (i.e. an acoustic signal generated by a particular source of interest) from the total signal acquired by an acoustic sensor may be achieved by identifying which bins correspond to the signal of interest, i.e. when and at which frequencies the signal of interest is active. Once such bins are identified, the total acquired signal may be masked by zeroing out the undesired time-frequency bins. Such an approach would be called a “hard mask.” Applying a so-called “soft mask” is also possible, the soft mask scaling the magnitude of each bin by some amount. Then an inverse transformation function (e.g. inverse STFT) may be applied to obtain the desired separated signal of interest in the time domain. Thus, masking in the frequency domain (i.e. in the domain of the transformation function) corresponds to applying a time-varying frequency-selective filter in the time domain.

The desired separated signal of interest may then be selectively processed for various purposes.

In some aspects, various approaches to processing of acoustic signals acquired at a user's device include one or both of acquisition of parallel signals from a set of closely spaced microphones, and use of a multi-tier computing where some processing is performed at the user's device and further processing is performed at one or more server computers in communication with the user's device. The acquired signals are processed using time versus frequency estimates of both energy content as well as direction of arrival. In some examples, intermediate processing data, e.g. characterizing direction of arrival information, may be passed from the user's device to a server computer where direction-based processing is performed.

One or more aspects of the present disclosure address a technical problem of providing accurate processing of acquired acoustic signals within the limits of computation capacity of a user's device. An approach of performing the processing of the acquired acoustic signals at the user's device permits reduction of the amount of data that needs to be transmitted to a server computer for further processing. Use of the server computer for the further processing, often involving speech recognition, permits use of greater computation resources (e.g., processor speed, runtime and permanent storage capacity, etc.) that may be available at the server computer.

In such a context, different computer-implemented methods outlining various BSS techniques described herein are now summarized. Each of the methods may be performed by one or more processing units, such as e.g. one or more processing units at a user's device and/or one or more processing units at one or more server computers in communication with the user's device.

One aspect of the present disclosure provides a first method for processing a plurality of signals acquired using a corresponding plurality of acoustic sensors, where the signals have contributions from a plurality of different acoustic sources. The first method is referred to herein as a “basic NTF” method. One step of the first method includes computing time-dependent spectral characteristics (e.g. quantities X representing a magnitude of the acquired signals) from at least one signal of the plurality of acquired signals. The computed spectral characteristics comprise a plurality of components, e.g. each component may be viewed as a value of X(f,n) assigned to a respective bin (f,n) of the plurality of time-frequency bins. The first method also comprises a step of computing direction estimates D from at least two signals of the plurality of acquired signals, each component of a first subset of the plurality of components having a corresponding one or more of the direction estimates. Thus, each time-frequency bin of a first subset of bins has a corresponding one or more direction estimates, where direction estimates either indicate possible direction of arrival of the component or indicate directions that are to be excluded from the possible direction of arrivals—i.e. directions that are definitely inappropriate/impossible can be ruled out. The first method further includes a step of performing iterations of a nonnegative tensor factorization (NTF) model for the plurality of acoustic sources, the iterations comprising a) combining values of a plurality of parameters of the NTF model with the computed direction estimates to separate from the acquired signals one or more contributions from a first acoustic source (s₁) of the plurality of acoustic sources.

As used in the present disclosure, unless otherwise specified, referring to a “subset” of the plurality of components is used to indicate that not all of the components need to be analyzed, e.g. to compute direction estimates. For example, some components may correspond to bins containing data that is too noisy to be analyzed. Such bins may then be excluded from the analysis.

In an embodiment of the first method, step (a) described above may include combining values of the plurality of parameters of the NTF model with the computed direction estimates to generate, using the NTF model, for each acoustic source of the plurality of acoustic sources, a spectrogram of the acoustic source (i.e., spectrogram estimating frequency contributions of the source). In one further embodiment of the first method, the step of performing the iterations may include comprises performing iterations of not only step (a) but also steps (b) and (c), where step (b) includes, for each acoustic source of the plurality of acoustic sources, scaling a portion of the spectrogram of the acoustic source corresponding to each component of a second subset of the plurality of components by a corresponding scaling factor to generate a scaled spectrogram of the acoustic source and step (c) includes updating values of at least some of the plurality of parameters based on the scaled spectrograms of the plurality of acoustic source.

It is to be understood that, as used in the present disclosure, the term “spectrogram” does not necessarily imply an actual spectrogram but any data indicative of at least a portion of such a spectrogram, providing a representation of the spectrum of frequencies in an acoustic signal as they vary with time or some other variable.

In an embodiment of the first method, the plurality of parameters used by the NTF model may include a direction distribution parameter q(d|s) indicating, for each acoustic source of the plurality of acoustic sources, probability that the acoustic source comprises (e.g. generates or has generated) one or more contributions in each of a plurality of the computed direction estimates.

In an embodiment, the first method may further include combining the computed spectral characteristics with the computed direction estimates to form a data structure representing a distribution indexed by time, frequency, and direction. Such a data structure may be a sparse data structure in which a majority of the entries of the distribution are absent or set to some predetermined value that is not taken into consideration when running the method. The NTF may then be performed using the formed data structure.

Another aspect of the present disclosure provides a second method for processing at least one signal acquired using a corresponding acoustic sensor, where the signal has contributions from a plurality of different acoustic sources. The second method is referred to herein as an “NTF with NN redux” method. One step of the second method includes computing time-dependent spectral characteristics (e.g. quantities X representing a magnitude of the acquired signals) from at least one signal of the plurality of acquired signals. Similar to the first method, the computed spectral characteristics comprise a plurality of components, e.g. each component may be viewed as a value of X(f,n) assigned to a respective bin (f,n) of the plurality of time-frequency bins. The second method also comprises a step of applying a first model to the time-dependent spectral characteristics, the first model configured to compute property estimates of a predefined property. Each component of a first subset of the components has a corresponding one or more property estimates of the predefined property (i.e., each time-frequency bin has a corresponding one or more likelihood estimates, where likelihood estimate either indicates how likely it is that the mass in that bin corresponds to a certain value of the property. For example, if the property is “direction,” the value could be e.g. “north by northeast”, “southwest”, or “perpendicular the plane of the microphone array.” In another example, if the property is “speech-like,” then the value could be e.g. “yes”, “no”, “probably.” The second method further includes a step of performing iterations of an NTF model for the plurality of acoustic sources, the iterations comprising a) combining values of a plurality of parameters of the NTF model with the computed property estimates to separate from the acquired signal one or more contributions from the first acoustic source.

In an embodiment of the second method, the following steps may be iterated: (a) combining values of the plurality of parameters of the NTF model with the computed property estimates to generate, using the NTF model, for each acoustic source, a spectrogram of the acoustic source, (b) for each acoustic source, scaling a portion of the spectrogram of the acoustic source corresponding to each component of a second subset of the plurality of components by a corresponding scaling factor to generate a scaled spectrogram of the acoustic source, and (c) updating values of at least some of the plurality of parameters based on the scaled spectrograms of the plurality of acoustic sources.

In an embodiment of the second method, the plurality of parameters used by the NTF model may include a property distribution parameter q(g|s) indicating, for each acoustic source of the plurality of acoustic sources, probability that the acoustic source comprises (e.g. generates or has generated) one or more contributions in each of a plurality of the computed property estimates.

In various embodiments, such a predefined property may include a direction of arrival, a component comprising a contribution from a specified acoustic source of interest, etc.

In an embodiment of the second method, the first model may be any classifier configured (e.g. designed and/or trained) to predict value(s) of the property. For example, the first model could comprise a neural network model, such as e.g. a deep neural net (DNN) model, a recurrent neural net (RNN) model, or a long short-term memory (LSTM) net model.

In an embodiment, the second method may further include combining the computed spectral characteristics with the computed property estimates to form a data structure representing a distribution indexed by time, frequency, and direction. Such a data structure may be a sparse data structure in which a majority of the entries of the distribution are absent or set to some predetermined value that is not taken into consideration when running the method. The NTF may then be performed using the formed data structure.

Yet another aspect of the present disclosure provides a third method for processing at least one signal acquired using a corresponding acoustic sensor, where the signal has contributions from a plurality of different acoustic sources. The third method is referred to herein as an “NN NTF” method. One step of the third method includes computing time-dependent spectral characteristics (e.g. quantities X representing a magnitude of the acquired signals) from at least one signal of the plurality of acquired signals. Similar to the first and second method, the computed spectral characteristics comprise a plurality of components, e.g. each component may be viewed as a value of X(f,n) assigned to a respective bin (f,n) of the plurality of time-frequency bins. The third method also comprises steps of accessing at least a first model configured to predict contributions from a first acoustic source of the plurality of acoustic sources, and performing iterations of an NTF model for the plurality of acoustic sources, the iterations comprising running the first model to separate from the at least one acquired signal one or more contributions from the first acoustic source.

In an embodiment of the third method, the following steps may be iterated: (a) combining values of the plurality of parameters of the first NTF model to generate, using the NTF model, for each acoustic source of the plurality of acoustic sources, a spectrogram of the acoustic source (i.e., spectrogram estimating frequency contributions of the source), (b) for each acoustic source, scaling a portion of the spectrogram of the acoustic source corresponding to each component of a first subset of the plurality of components by a corresponding scaling factor to generate a scaled spectrogram of the acoustic source, and (c) running the first model using at least a portion of the scaled spectrogram as an input to the first model to update values of at least some of the plurality of parameters.

In an embodiment, the third method may further use direction data. In such an embodiment, at least one further signal is acquired using a corresponding further acoustic sensor, the method further includes computing direction estimates D from the two acquired signals, each component of a second subset of the plurality of components having a corresponding one or more of the direction estimates, and the spectrogram for each acoustic source is generated by combining the values of the plurality of parameters of the NTF model with the computed direction estimates.

In one further embodiment of the third method where the direction data is used, the plurality of parameters used by the NTF model may include a direction distribution parameter q(d Is) indicating, for each acoustic source of the plurality of acoustic sources, probability that the acoustic source comprises (e.g. generates or has generated) one or more contributions in each of a plurality of the computed direction estimates.

In an embodiment, the third method may be combined with the second method, resulting in what is referred to herein as a “NN NTF with NN redux” method. In such an embodiment, the third method further includes a step of applying a second model to the time-dependent spectral characteristics, the second model configured to compute property estimates G of a predefined property, each component of a third subset of the components having a corresponding one or more property estimates of the predefined property. In such an embodiment, the spectrogram is generated by combining the values of the plurality of parameters of the NTF model with the computed property estimates.

In an embodiment of the NN NTF with NN redux method, the plurality of parameters used by the NTF model may include a property distribution parameter q(g|s) indicating, for each acoustic source, probability that the acoustic source comprises (e.g. generates or has generated) one or more contributions in each of a plurality of the computed property estimates. In various further embodiments, such a predefined property may include a direction of arrival, a component comprising a contribution from a specified acoustic source of interest, etc.

In various embodiments of the third method, each of the first and the second models may be any classifier configured (e.g. designed and/or trained) to predict value(s) of the property. For example, each of the first and the second models could comprise a neural network model, such as e.g. a DNN model, an RNN model, or an LSTM net model. The first and the second models may, but do not have to, be the same models.

In each of an embodiment of the first method and an embodiment of the third method where the direction data is used, the step of computing the direction estimates of a component may include computing data representing one or more directions of arrival of the component in the acquired signals. In one further embodiment, computing the data representing the direction of arrival may include one or both of computing data representing one or more directions of arrival and computing data representing an exclusion of at least one direction of arrival. Alternatively or additionally, computing the data representing the direction of arrival may include determining one or more optimized directions associated with the component using at least one of phases and times of arrivals of the acquired signals, where determination of the optimized one or more directions may include performing at least one of a pseudo-inverse calculation and a least-square-error estimation.

In various embodiments, each of the first, second, and third methods may further include steps of using the values of the plurality of parameters of the NTF model following completion of the iterations to generate a mask Mₛ₁ for identifying the one or more contributions from the first acoustic source s₁ to the time-dependent spectral characteristics X, and applying the generated mask Mₛ₁ to the time-dependent spectral characteristics X to separate the one or more contributions from the first acoustic source.

In various embodiments, each of the first, second, and third methods may further include a step of initializing the plurality of parameters of the NTF model by assigning a value of each parameter to an initial value.

In various embodiments, each of the first, second, and third methods may further include a step of applying a transformation function to transform at least portions of the at least one signal of the plurality of acquired signals from a time domain to a frequency domain, where the time-dependent spectral characteristics are computed based on an outcome of applying the transformation function. Each of these methods may further include a step of applying an inverse transformation function to transform the separated one or more contributions from the first acoustic source to the time domain. In various further embodiments, the transformation function may be an FFT. In another further embodiment, each component of the plurality of components of the spectral characteristics may comprise a value of the spectral characteristic associated with a different range of frequencies and with a different time range (i.e., each component comprises spectral characteristics assigned to a particular time-frequency bin). In yet another further embodiment, the spectral characteristics may include values indicative of magnitudes of the at least one signal of the plurality of acquired signals.

In an embodiment of each of the first, second, and third methods, each component of the plurality of components of the time-dependent spectral characteristics may be associated with a time frame of a plurality of successive time frames.

In an embodiment of each of the first, second, and third methods, each component of the plurality of components of the time-dependent spectral characteristics may be associated with a frequency range, whereby the computed components form a time-frequency characterization of the at least one acquired signal.

In an embodiment of each of the first, second, and third methods, each component of the plurality of components of the time-dependent spectral characteristics may represent energy of the at least one acquired signal at a corresponding range of time and frequency.

In another aspect, in general, yet a method for processing a plurality of signals acquired uses a corresponding plurality of acoustic sensors at a client device. The signals have parts from a plurality of spatially distributed acoustic sources. The method comprises: computing, using a processor at the client device, time-dependent spectral characteristics from at least one signal of the plurality of acquired signals, the spectral characteristics comprising a plurality of components; computing, using the processor at the client device, direction estimates from at least two signals of the plurality of acquired signals, each computed component of the spectral characteristics having a corresponding one of the direction estimates; performing a decomposition procedure using the computed spectral characteristics and the computed direction estimates as input to identify a plurality of sources of the plurality of signals, each component of the spectral characteristics having a computed degree of association with at least one of the identified sources and each source having a computed degree of association with at least one direction estimate; and using a result of the decomposition procedure to selectively process a signal from one of the sources.

Each component of the plurality of components of the time-dependent spectral characteristics computed from the acquire signals is associated with a time frame of a plurality of successive time frames. For example, each component of the plurality of components of the time-dependent spectral characteristics computed from the acquired signals is associated with a frequency range, whereby the computed components form a time-frequency characterization of the acquired signals. In at least some examples, each component represents energy (e.g., via a monotonic function, such as square root) at a corresponding range of time and frequency.

Computing the direction estimates of component comprises computing data representing a direction of arrival of the component in the acquired signals. For example, computing the data representing the directional of arrival comprises at least one of (a) computing data representing one direction of arrival, and (b) computing data representing an exclusion of at least one direction of arrival. As another example, computing the data representing the direction of arrival comprises determining an optimized direction associated with the component using at least one of (a) phases, and (b) times of arrivals of the acquired signals. The determining of the optimized direction may comprise performing at least one of (a) a pseudo-inverse calculation, and (b) a least-squared-error estimation. Computing the data representing the direction of arrival may comprise computing at least one of (a) an angle representation of the direction of arrival, (b) a direction vector representation of the direction of arrival, and (c) a quantized representation of the direction of arrival.

Performing the decomposing comprises combining the computed spectral characteristics and the computed direction estimates to form a data structure representing a distribution indexed by time, frequency, and direction. For example, the method may comprise performing a non-negative matrix or tensor factorization using the formed data structure. In some examples, forming the data structure comprises forming data structure representing a sparse data structure in which a majority of the entries of the distribution are absent.

Performing the decomposition comprises determining the result including a degree of association of each component with a corresponding source. In some examples, the degree of association comprises a binary degree of association.

Using the result of the decomposition to selectively process the signal from one of the sources comprises forming a time signal as an estimate of a part of the acquired signals corresponding to said source. For example, forming the time signal comprises using the computed degrees of association of the components with the identified sources to form said time signal.

Using the result of the decomposition to selectively process the signal from one of the sources comprises performing an automatic speech recognition using an estimated part of the acquired signals corresponding to said source.

At least part of performing the decomposition process and using the result of the decomposition procedure is performed as a server computing system in data communication with the client device. For example, the method further comprises communicating from the client device to the server computing system at least one of (a) the direction estimates, (b) a result of the decomposition procedure, and (c) a signal formed using a result of the decomposition as an estimate of a part of the acquired signals. In some examples, the method further comprises communicating a result of the using of the result of the decomposition procedure from the server computing system to the client device. In some examples, the method further comprises communicating data from the server computing system to the client device for use in performing the decomposition procedure at the client device.

In still another aspect of the present disclosure, another method for processing at least one signal acquired using an acoustic sensor is provided, the method referred to herein as a “streaming NTF.” Again, the at least one signal has contributions from a plurality of acoustic sources. The streaming NTF method includes steps of accessing an indication of a current block size, the current block size defining a size of a portion (referred to herein as a “block”) of the at least one signal to be analyzed to separate from the at least one signal one or more contributions from a first acoustic source of the plurality of acoustic sources and analyzing a first and a second portions of the at least one signal. The second portion is temporaly shifted (i.e., shifted in time) with respect to the first portion. In one embodiment, both the first and the second portions are portions of the current block size. In other embodiments, the first and second portions may be of different sizes. The first portion is analyzed by computing one or more first characteristics from data of the first portion, and using the computed one or more first characteristics, or derivatives thereof, in performing iterations of an NTF model for the plurality of acoustic sources for the data of the first portion to separate, from at least the first portion of the at least one acquired signal, one or more first contributions from the first acoustic source. The second portion is analyzed by computing one or more second characteristics from data of the second portion, and using the computed one or more second characteristics, or derivatives thereof, in performing iterations of the NTF model for the data of the second portion to separate, from at least the second portion of the at least one acquired signal, one or more second contributions from the first acoustic source.

In various embodiments of the streaming NTF method, accessing the indication of the current block size may include either receiving user input providing the indication of the current block size or a derivative thereof or computing the current block size based on one or more factors, such as e.g. one or more of the amount of unprocessed data available (in a networked setting this might be variable), the amount of processing resources available such as processor cycles, main memory, cache memory, or register memory, and acceptable latency for the current application.

In an embodiment of the streaming NTF method, the first portion and the second portion may overlap in time.

In an embodiment of the streaming NTF method, past statistics about previous iterations of the NTF model (for earlier blocks) may be advantageously taken into consideration. In such an embodiment, the method may further include using one or more past statistics computed from data of a past portion of the at least one signal in performing the iterations of the NTF model for the data of the first portion and/or for the data of the second portion, where the past portion may include a portion of the at least one signal that has been analyzed to separate from the at least one signal one or more contributions from the first acoustic source.

In an embodiment of the streaming NTF method, the past portion may comprise a plurality of portions of the at least one signal, each portion of the plurality of portions being of the current block size, and the one or more past statistics from the data of the past portion may comprise a combination of one or more characteristics computed from data of each portion of the plurality of portions and/or results of performing iterations of the NTF model for the data of the each portion. In this manner, the past summary statistics may be a combination of statistics from analyzing various blocks. In one further embodiment, the plurality of portions may overlap in time.

In an embodiment of the streaming NTF method, the method may further include storing information indicative of one or more of: the one or more first characteristics, results of performing iterations of the NTF model for the data of the first portion, the one or more second characteristics, and results of performing iterations of the NTF model for the data of the second portion as a part of the one or more past characteristics. In this manner, past statistics may be accumulated. In an embodiment, computing the past statistics involves adding some NTF parameters from the most recent runs of the NTF model to the statistics available before that time (i.e., the previous past statistics). In an embodiment, accumulating past statistics goes beyond merely storing the NTF parameters, but involve compute some kind of derivative based on these parameters. In addition to the items listed above, in an embodiment, the computed past characteristics may further depend on the previous past characteristics.

In various embodiments, streaming NTF approach is applicable to a conventional NMF approach for source separation as well as to any of the source separation methods described herein, such as e.g. the basic NTF, NN NTF, basic NTF with NN redux, and NN NTF with NN redux.

In an embodiment of any of the methods described herein, a first subset of the steps of any of the methods may be performed by a client device and a second subset of the steps may be performed by a server. In such an embodiment, the method includes performing, at the client device, the first subset of the steps, providing, from the client device to the server, at least a part of an outcome of performing the first subset of the steps, and at least partially based on the at least part of the outcome provided from the client device, performing, at the server, the second subset of the steps. In an embodiment, the first subset and the second subset of the steps may be overlapping (i.e. a step or a part of a step of a particular method may be performed by both the client device and the server).

In another aspect, in general, a signal processing system, which comprises a processor and an acoustic sensor having one or more sensor elements, is configured to perform all the steps of any one of methods set forth above.

In another aspect, in general, a signal processing system comprises an acoustic sensor, integrated in a client device, device possibly having multiple sensor elements, and a processor also integrated in the client device. The processor of the client device is configured to perform at least some of the steps of any one of methods described herein. The rest of the steps may be performed by a processor integrated in a remote device, such as e.g. a server. In such examples, the system further comprises a communication interface that enables communication between the client device and the server and allows the client device and the server to exchange, as needed, results of their respective processing. In an embodiment, a step or a part of a step of a particular method may be performed by both the client device and the server.

Furthermore, the present disclosure includes apparatus, systems, and computerized methods for providing cloud-based blind source separation services carrying out any of the source separation processing steps described herein, such as, but not limited to, the source separation processing steps in accordance with the basic NTF, NN NTF, basic NTF with NN redux, NN NTF with NN redux, and streaming NTF methods, and any combinations of these methods.

One computerized method for providing source separation includes steps of receiving, by a computing device, partially-processed acoustic data from a client device, the data having at least one component of source-separation processing already completed prior to the data being received; processing, by the computing device, the partially-processed acoustic data to generate source-separated data; and providing, by the computing device, the generated source-separated data for acoustic signal processing. In accordance with some aspects, the computing device may comprise a distributed computing system communicating with the client device over a network.

Embodiments may also include, prior to receiving partially-processed acoustic data from a client device, identifying a plurality of source-separation processing steps; and allocating each of the identified source-separation processing steps as to either the client device or a cloud computing device, wherein the at least one component of source-separation processing already completed prior to the data being received comprises the identified source-separation processing steps allocated to the client device, and wherein further processing comprises executing the identified processing steps allocated to the cloud computing device.

Some aspects may determine at least one instruction by means of the acoustic signal processing. The instruction may be provided to the client device and/or to a third party device for execution.

In accordance with some aspects, the at least one component of source-separation processing already completed may include at least one of ambient noise reduction, feature identification, and compression.

In accordance with some aspects, the further processing may be carried out using data collected from a plurality of sources other than the client device. The further processing may include comparing the received data to a plurality of samples of acoustic data; and for each sample, providing an evaluation of the confidence that the sample matches the received data. The further processing may include applying a hierarchical model to identify one or more features of the received data.

In another embodiment, a computerized method for providing source separation includes steps of: receiving, by a cloud computing device, acoustic data from a client device; processing, by the cloud computing device, the acoustic data to generate source-separated data; and providing, by the computing device, the generated source-separated data for acoustic signal processing.

In accordance with some aspects, processing the acoustic data may include using distributed processing over a plurality of processers in order to process the data.

In accordance with some aspects, processing the acoustic data may include using a template database including a plurality of audio samples in order to process the data.

As will be appreciated by one skilled in the art, aspects of the present disclosure may be embodied in various manners—e.g. as a method, a system, a computer program product, or a computer-readable storage medium. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more processing units, e.g. one or more microprocessors, of one or more computers. In various embodiments, different steps and portions of the steps of each of the methods described herein may be performed by different processing units, such as e.g. by a processing unit which may be incorporated within a client device that acquires the acoustic signals and a processing unit that is operating on another device, such as e.g. a processing unit of a remote server. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. to the existing client devices, acoustic sensor arrays, various control nodes, etc.) or be stored upon manufacturing of these devices and systems.

Other features and advantages of the invention are apparent from the following description, and from the claims.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a diagram illustrating a representative client device according to some embodiments of the present disclosure;

FIG. 2 is a diagram illustrating a flow chart of method steps leading to separation of audio signals according to some embodiments of the present disclosure;

FIG. 3 is a diagram illustrating a Non-Negative Matrix Factorization (NMF) approach to representing a signal distribution according to some embodiments of the present disclosure;

FIG. 4 is a diagram illustrating a flow chart of method steps leading to separation of acoustic signals using direction data according to some embodiments of the present disclosure;

FIG. 5 is a diagram illustrating a flow chart of method steps leading to separation of acoustic signals using property estimates according to some embodiments of the present disclosure;

FIG. 6 illustrates a cloud-based blind source separation system according to some embodiments of the present disclosure;

FIGS. 7A-C illustrate how blind source separation processing may be partitioned in different ways between a local client and the cloud according to some embodiments of the disclosure;

FIG. 8 is a flowchart describing an exemplary method according to some embodiments of the present disclosure; and

FIG. 9 is a flowchart representing an exemplary method 900 for cloud based source separation according to some embodiments of the present disclosure.

### DESCRIPTION OF EXAMPLE EMBODIMENTS OF THE DISCLOSURE

### Exemplary Setting for Acquisition of Audio Signals

Use of spoken input for user devices, e.g. smartphones, can be challenging due to presence of other sound sources. BSS techniques aim to separate a sound generated by a particular source of interest from a mixture of various sounds. Various BSS techniques disclosed herein are based on recognition that providing additional information that is considered within iterations of an nonnegative matrix factorization (NMF) model, thus making a model a nonnegative tensor factorization model due to the presence of at least one extra dimension in the model (hence, “tensor” instead of “matrix”), improves accuracy and efficiency of source separation. Examples of such information include direction estimates or neural network models trained to recognize a particular sound of interest. Furthermore, identifying and processing incremental changes to an NTF model, rather than re-processing the entire model each time data changes, provides an efficient and fast manner for performing source separation on large sets of quickly changing data. Carrying out at least parts of BSS techniques in a cloud allows flexible utilization of local and remote resources.

In general, embodiments described herein are directed to a problem of acquiring a set of audio signals, which typically represent a combination of signals from multiple sources, and processing the signals to separate out a signal of a particular source of interest, or multiple signals of interest, from other undesired signals. At least some of the embodiments are directed to the problem of separating out the signal of interest for the purpose of automated speech recognition when the acquired signals include a speech utterance of interest as well as interfering speech and/or non-speech signals. Other embodiments are directed to problem of enhancement of the audio signal for presentation to a human listener. Yet other embodiments are directed for other forms of automated speech processing, for example, speaker verification or voice-based search queries.

Embodiments also include one or both of (a) carrying out the source separation methods are described herein, and (b) processing the audio signals in a multi-tier architecture in which different parts of the processing may be performed on different computing devices, for example, in a client-server arrangement. It should be understood that these two aspects are independent and that some embodiments may carry out the source separation methods on a single computing device, and that other embodiments may not carry out the source separation methods, but may nevertheless use a multi-tier architecture. Finally, at least some embodiments may neither use directional information nor multi-tier architectures, for example, using only time-frequency factorization approaches described below.

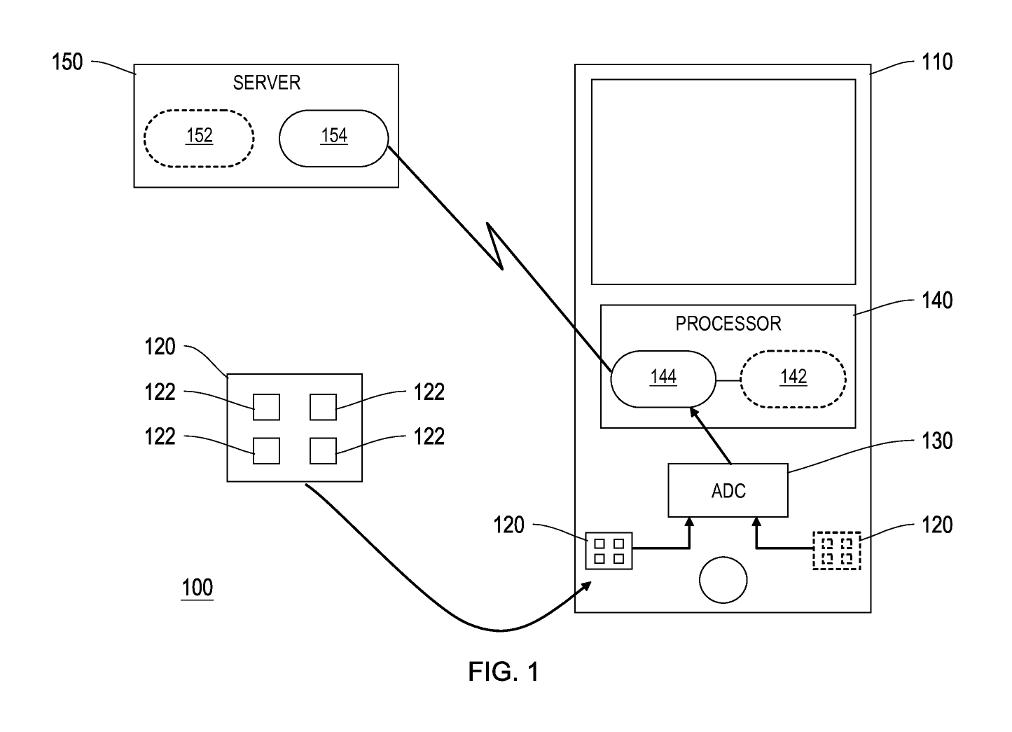

Referring to FIG. 1, features that may be present in various embodiments are described in the context of an exemplary embodiment in which one or more client devices, such as e.g. personal computing devices, specifically smartphones 110 (only one of which is shown in FIG. 1) include one or more microphones 120, each of which has multiple closely spaced elements (e.g., 1.5 mm, 2 mm, 3 mm spacing). The analog signals acquired at the microphone(s) 120 are provided to an Analog-to-Digital Converter (ADC) 130, which, in turn, provides digitized audio signals acquired at the microphone(s) 120 to a processor 140 coupled to the ADC 130. The processor includes a storage/memory 142, which is used in part for data representing the acquired acoustic signals, and a processing unit 144 which implements various procedures described below.

In an embodiment, the smartphone 110 may be coupled to a server 150 over any kind of network that offers communicative interface between clients such as client devices, e.g. the smartphone 110, and servers such as e.g. the server 150. In various embodiments, such a network could be a cellular data network, any local area network (LAN), wireless local area network (WLAN), metropolitan area network (MAN), Intranet, Extranet, Internet, WAN, virtual private network (VPN), or any other appropriate architecture or system that facilitates communications in a network environment depending on the network topology.

The server also includes a storage 152 and a CPU 154. In various embodiments, data may be exchanged between the smartphone and the server during and/or immediately following the processing of the audio signals acquired at the smartphone. For example, partially processed audio signals are passed from the smartphone to the server, and results of further processing (e.g., results of automated speech recognition) are passed back from the server to the smartphone. In an embodiment, the partially processed audio signals may merely comprise acquired audio signals being converted into digital signals by the ADC 120. In another example, the server 150 may be configured to provide data to the smartphone, e.g. estimated directionality information or spectral prototypes for the sources, which may be used by the processor 140 of the smartphone to fully or partially process audio signals acquired at the smartphone.

It should be understood that a smartphone application is only one of a variety of examples of client devices. In various embodiments, the device 110 may be any device, such as e.g. an audio signal acquisition device integrated in a vehicle. Furthermore, while the device 110 is referred to herein as a “client device”, in various embodiments, such a device may or may not be operated by a human user. For example, the device 110 could be any device participating in machine-to-machine (M2M) communication where differentiation between the acoustic sources may be desired.

In one embodiment, the multiple element microphone 120 may acquire multiple parallel audio signals. For example, the microphone may acquire four parallel audio signals from closely spaced elements 122 (e.g., spaced less than 2 mm apart) and passes these as analog signals (e.g., electric or optical signals on separate wires or fibers, or multiplexed on a common wire or fiber) x₁(t), . . . , x₄(t) to the ADC 130.

Separating an Audio Mixture into Component Sources

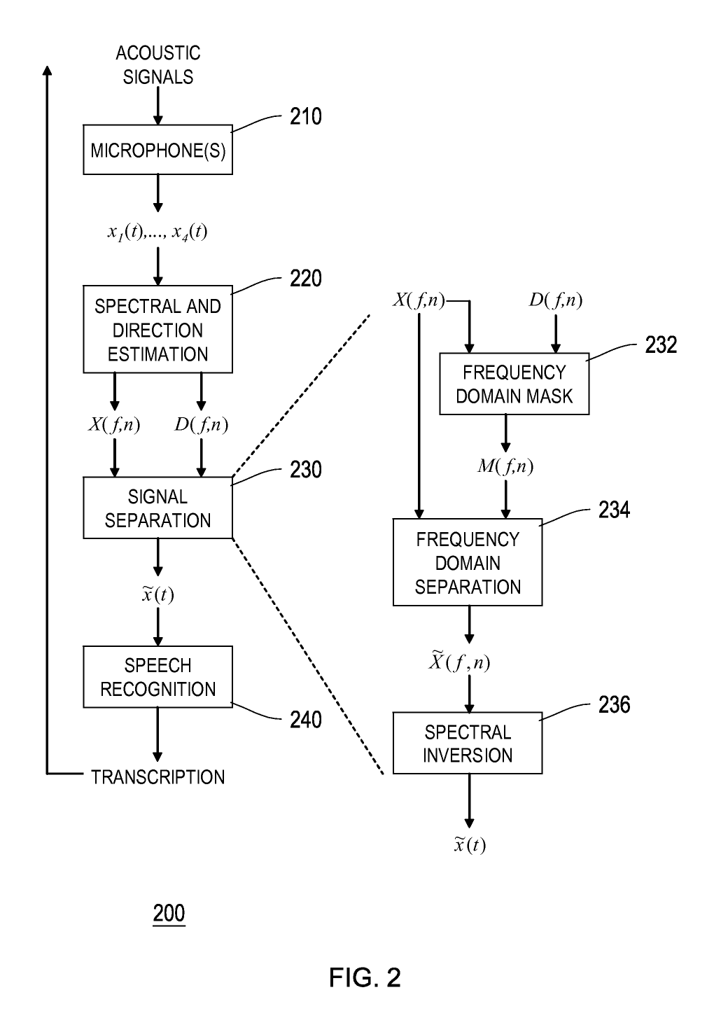

FIG. 2 is a diagram illustrating a flow chart 200 of method steps leading to separation of audio signals, according to an embodiment of the present disclosure.

As shown in FIG. 2, the method 200 may begin with a step 210 where acoustic signals are received by the microphone(s) 120, resulting in signals x₁(t), . . . , x₄(t) corresponding to the four microphone elements 122 shown in an exemplary illustration of FIG. 1 (of course, teachings described herein are applicable to any number of microphone elements). Each of the signals x₁(t), . . . , x₄(t) represents a mixture of the acoustic signals, as detected by the respective microphone element 122. Digitized signals x₁(t), . . . , x₄(t) generated in step 210 are passed to a processor, e.g. to a local processing unit such as the processing unit 144 and/or to a remote processing unit such as the processing unit 154, for signal processing.

In step 220, the processing unit performs spectral estimation and direction estimation, described in greater detail below, thereby producing magnitude and direction information X(f,n) and D(f,n), where f is an index over frequency bins and n is an index over time intervals (i.e., frames). As used herein, the term “direction estimate” refers to any representation of a direction such as, but not limited to, a single direction or at least some representation of direction that excludes certain directions or renders certain directions to be substantially unlikely.

The information generated in step 220 is then used in a signal separation step 230 to produce one or more separated time signals \tilde{x}(t), thereby separating the audio mixture received in step 210 into component sources. The one or more separated signals produced in step 230 may, optionally, be passed to a speech recognition step 240, e.g. to produce a transcription.

### Spectral and Direction Estimation

Step 220 is now described in greater detail.

In general, processing of the acquired audio signals includes performing a time frequency analysis from which positive real quantities X(f,n) representing magnitudes of the signals may be derived. For example, Short-Time Fourier Transform (STFT) analysis may be performed on the time signals in each of a series of time windows (“frames”) shifted 30 milliseconds (ms) per increment with 1024 frequency bins, yielding 1024 complex quantities per frame for each input signal. When presented in a polar form, each complex quantity represents the magnitude of the signal and the angle, or the phase, of the signal. In some implementations, one of the input signals may be chosen as a representative, and the quantity X(f,n) may be derived from the STFT analysis of the time signal, with the angle of the complex quantities being retained for later reconstruction of a separated time signal. In some implementations, rather than choosing a representative input signal, a combination (e.g., weighted average or the output of a linear beam former based on previous direction estimates) of the time signals or their STFT representations is used for forming X(f,n) and the associated phase quantities.

In various embodiments, positive real quantities X(f,n) representing magnitudes of the signals could be presented in various manners, not only as an actual magnitude, but also e.g. as a squared magnitude, or as a compressive transformation of the magnitude, such as a square root. Unless specified otherwise, description of the quantities X(f,n) as representing magnitudes is applicable to any kind of magnitude representation.

In addition to the magnitude-related information, direction-of-arrival (DOA) information is computed from the time signals, also indexed by frequency and frame. For example, continuous incidence angle estimates D(f,n), which may be represented as a scalar or a multi-dimensional vector, are derived from the phase differences of the STFT.

An example of a particular direction of arrival calculation approach is as follows. The geometry of the microphones is known a priori and therefore a linear equation for the phase of a signal each microphone can be represented as \vec{a}ₖ□\vec{d}+δ₀=δₖ, where \vec{a}ₖ is the three-dimensional position of the k^{th} microphone, \vec{d} is a three-dimensional vector in the direction of arrival, δ₀ is a fixed delay common to all the microphones, and δₖ=φₖ/ωᵢ is the delay observed at the k^{th} microphone for the frequency component at frequency ωᵢ computed from the phase φₖ of the complex STFT of the k^{th} microphone. The equations of the multiple microphones can be expressed as a matrix equation Ax=b where A is a K×4 matrix (K is the number of microphones) that depends on the positions of the microphones, x represent the direction of arrival (a 4-dimensional vector having \vec{d} augmented with a unit element), and b is a vector that represents the observed K phases. This equation can be solved uniquely when there are four non-coplanar microphones. If there are a different number of microphones or this independence isn't satisfied, the system can be solved in a least squares sense. For fixed geometry the pseudoinverse P of A can be computed once (e.g., as a property of the physical arrangement of ports on the microphone) and hardcoded into computation modules that implement an estimation of direction of arrival x as Pb. The direction D is then available directly from the vector direction x. In some examples, the magnitude of the direction vector x, which should be consistent with (e.g., equal to) the speed of sound, is used to determine a confidence score for the direction, for example, representing low confidence if the magnitude is inconsistent with the speed of sound. In some examples, the direction of arrival is quantized (i.e., binned) using a fixed set of directions (e.g., 20 bins), or using an adapted set of directions consistent with the long-term distribution of observed directions of arrival.

Note that the use of the pseudo-inverse approach to estimating direction information is only one example, which is suited to the situation in which the microphone elements are closely spaced, thereby reducing the effects of phase “wrapping.” In other embodiments, at least some pairs of microphone elements may be more widely spaced, for example, in a rectangular arrangement with 36 mm ad 63 mm spacing. In such an arrangement, and alternative embodiment makes use of techniques of direction estimation (e.g., linear least squares estimation) as e.g. described in International Application Publication WO2014/047025, titled “SOURCE SEPARATION USING A CIRCULAR MODEL.” In yet other embodiments, a phase unwrapping approach is applied in combination with a pseudo-inverse approach as described above, for example, using an unwrapping approach to yield approximate delay estimates, followed by application of a pseudo-inverse approach. Of course, one skilled in the art would understand that yet other approaches to processing the signals (and in particular processing phase information of the signals) to yield a direction estimate can be used.

### Source Separation According to Basic NTF

There are many ways in which step 230 may be carried out according to various embodiments of the present disclosure. Those representing what is referred to herein as a “basic Nonnegative Tensor Factorization (NTF)” are now described in greater detail. The word “basic” in the expression “basic NTF” is used to highlight the difference from other NTF-based implementations described herein, in particular a Neural Net (NN) NTF, NTF with NN Redux, NN NTF with NN Redux, and Streaming NTF.

Continuing to refer to FIG. 2, one implementation of the signal separation stage 230 may involve first performing a frequency domain mask step 232, which produces a mask M(f,n). This mask is then used in step 234 to perform signal separation in the frequency domain producing \tilde{X}(f,n), which is then passed to a spectral inversion stage 236 in which the time signal \tilde{x}(t) is determined for example using an inverse transform. Note that in FIG. 2, the flow of the phase information (i.e., the angle of complex quantities indexed by frequency f and time frame n) associated with X(f,n) and \tilde{X}(f,n) is not shown.

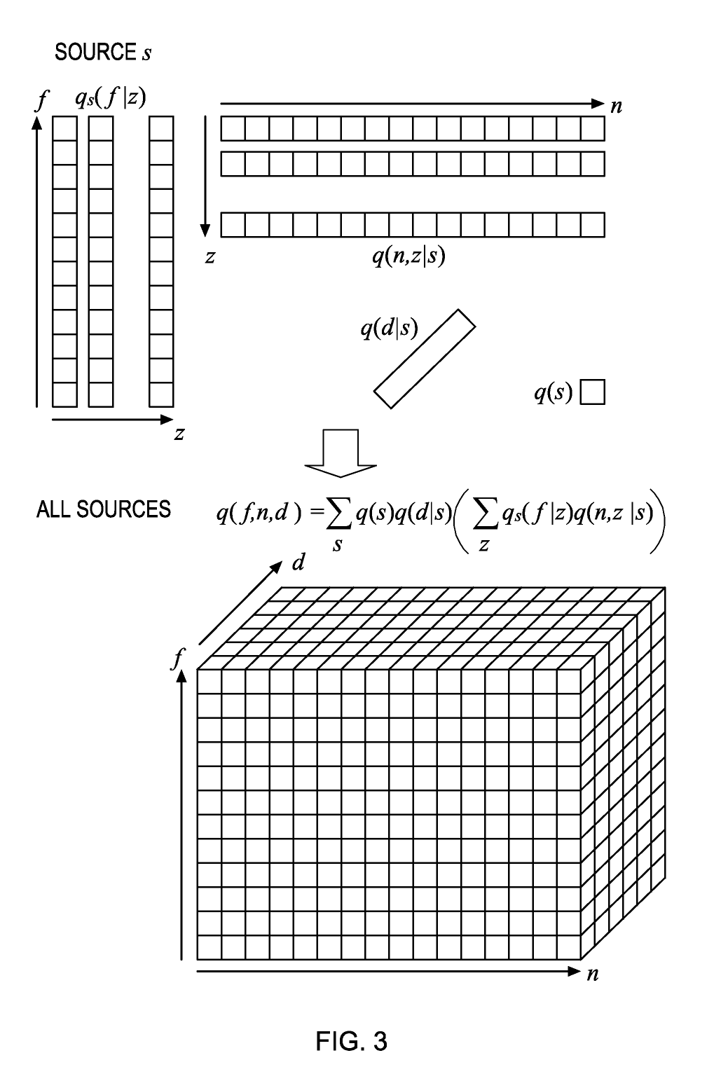

As discussed more fully below, different embodiments implement the signal separation stage 230 in somewhat different ways. Referring to FIG. 3, one approach involves treating using the computed magnitude and direction information from the acquired signals as a distribution

$$p ( f , n , d ) = p ( f , n ) p ( d \vert f , n )$$

$$where$$

$$p ( f , n ) = ( \frac{X ( f , n )}{{\sum }_{{f}^{′} , {n}^{′}} X ( {f}^{′} , {n}^{′} )} )$$

$$and$$

$$p ( d \vert f , n ) = \{ \begin{matrix}1 & if D ( f , n ) = d \\ 0 & otherwise\end{matrix}$$

Notation “distribution (A|B)” is used to describe a distribution with respect to A for a given B. For example p(d|f, n) is used to describe a probability distribution over directions for a fixed frequency f and frame n.

The distribution p(f,n,d) can be thought of as a probability distribution in that the quantities are all in the range 0.0 to 1.0 and the sum over all the index values is 1.0. Also, it should be understood that the direction distributions p(d|f,n) are not necessarily 0 or 1, and in some implementations may be represented as a distribution with non-zero values for multiple discrete direction values d. In some embodiments, the distribution may be discrete (e.g., using fixed or adaptive direction “bins”) or may be represented as a continuous distribution (e.g., a parameterized distribution) over a one-dimensional or multi-dimensional representation of direction.

Very generally, a number of implementations of the signal separation approach are based on forming an approximation q(f,n,d) of p(f,n,d), where the distribution q(f,n,d) has a hidden multiple-source structure, i.e. a structure that includes multiple sources where little or no information about the sources is known.

Referring to FIG. 3, one approach to representing the hidden multiple source structure is using a non-negative matrix factorization (NMF) approach, and, more generally, a non-negative tensor (i.e., three or more dimensional) factorization (NTF) approach. The signal is assumed to have been generated by a number of distinct sources, indexed by s=1, . . . , S. Each source is also associated with a number of prototype frequency distributions indexed by z=1, . . . , Z. The prototype frequency distributions q(f|z, s) 410 provide relative magnitudes of various frequency bins, which are indexed by f. The time-varying contributions of the different prototypes for a given source is represented by terms q(n, z|s) 420, which sum to 1.0 over the time frame index values n and prototype index values z. Absent direction information, the distribution over frequency and frame index for a particular source s can be represented as

$$q ( f , n \vert s ) = {\sum }_{z} q ( f \vert z , s ) q ( n , z \vert s )$$

Direction information in this model is treated, for any particular source, as independent of time and frequency or the magnitude at such times and frequencies. Therefore a distribution q(d|s) 430, which sums to 1.0 for each s, is used. A relative contribution of each source, q(s) 440, sum to 1.0 over the sources. In some implementations, the joint quantity q(d,s)=q(d|s)q(s) is used without separating into the two separate terms. Note that in alternative embodiments, other factorizations of the distribution may be used. For example, q(f,n|s)=Σ_{z} q(f,z|s)q(n|z,s) may be used, encoding an equivalent conditional independence relationship.

The overall distribution q(f,n,d) is then determined from the constituent parts as follows:

$$q ( f , n , d ) = {\sum }_{s , z} q ( f , n , d , s , z ) = {\sum }_{s} q ( s ) q ( d \vert s ) ( {\sum }_{z} q ( f \vert z , s ) q ( n , z \vert s ) )$$

In general, operation of the signal separation phase finds the components of the model to best match the distribution determined from the observed signals. This is expressed as an optimization to minimize a distance between the distribution p( ) determined from the actually observed signals, and q( ) formed from the structured components, the distance function being represented as D(p(f,n,d)∥q(f,n,d)). A number of different distance functions may be used. One suitable function is a Kullback-Leibler (KL) divergence, defined as

$${D}_{KL} ( p ( f , n , d ) \vert \vert q ( f , n , d ) ) = {\sum }_{f , n , d} p ( f , n , d ) ln \frac{p ( f , n , d )}{q ( f , n , d )}$$

For the KL distance, a number of alternative iterative approaches can be used to find the best structure of q(f,n,d,s,z). One alternative is to use an Expectation-Maximization procedure (EM), or another example of a Minorization-Maximization (MM) procedure. An implementation of the MM procedure used in at least some embodiments can be summarized as follows:
1) Current estimates (indicated by the superscript 0) are known providing the current estimate:

q⁰(f,n,d,s,z)=q⁰(d,s)q⁰ₛ(f|z)q⁰(n,z|s)
2) A marginal distribution is computed (at least conceptually) as

$${q}^{0} ( s , z \vert f , n , d ) = {q}^{0} ( f , n , d , s , z ) / {\sum }_{s , z} {q}^{0} ( f , n , d , s , z )$$

3) A new joint distribution is computed as

r(f,t,d,s,z)=p(f,n,d)q⁰(s,z|f,n,d)
4) New estimates of the components (index by the superscript 1) are computed (at least conceptually) as

$${q}^{1} ( d , s ) = {\sum }_{f , n , z} r ( f , n , d , s , z ) , \\ {q}^{1} ( f \vert s , z ) = {\sum }_{n , d} r ( f , n , d , s , z ) / {\sum }_{f , n , d} r ( f , n , d , s , z ) , and$$

$${q}^{1} ( n , z \vert s ) = {\sum }_{f , d} r ( f , n , d , s , z ) / {\sum }_{f , n , d , z} r ( f , n , d , s , z ) .$$

In some implementations, the iteration is repeated a fixed number of times (e.g., 10 times). Alternative stopping criteria may be used, for example, based on the change in the distance function, change in the estimated values, etc. Note that the computations identified above may be implemented efficiently as matrix computations (e.g., using matrix multiplications), and by computing intermediate quantities appropriately.

In some implementations, a sparse representation of p(f,n,d) is used such that these terms are zero if d≠D(f,n). Steps 2-4 of the iterative procedure outlined above can then be expressed as
2) Compute

ρ(f,n)=p(f,n)/q⁰(f,n,D(f,n))
3) New estimates are computed as

$${q}^{1} ( d , s ) = {q}^{0} ( d , s ) {\sum }_{f , n : D ( f , n ) = d} ρ ( f , n ) {q}^{0} ( f , n \vert s ) , \\ {q}^{1} ( f , s , z ) = {q}^{0} ( f \vert s , z ) {\sum }_{n} ρ ( f , n ) {q}^{0} ( D ( f , n ) , s ) {q}^{0} ( n , z \vert s ) ,$$

and
q¹(n, z|s) is computed similarly.

Once the iteration is completed, the per-source mask function may be set as

$${M}_{s} ( f , n ) = q ( s \vert f , n ) = {\sum }_{d , z} q ( f , n , d , s , z ) / {\sum }_{d , s , z} q ( f , n , d , s , z )$$

In some examples, the index s* of the desired source is determined by the estimated direction q(d|s) for the source (e.g., the desired source is in a desired direction), the relative contribution of the source q(s) (e.g., the desired source has the greatest contribution), or both.

A number of different approaches may be used to separate the desired signal using a mask.

In one approach, a thresholding approach is used, for example, by setting

$$\tilde{X} ( f , n ) = \{ \begin{matrix}X ( f , n ) & if {M}_{{s}^{*}} ( f , n ) > thresh \\ 0 & otherwise\end{matrix}$$

In another approach, a “soft” masking is used, for example, scaling the magnitude information by M_{s*}(f,n), or some other monotonic function of the mask, for example, as an element-wise multiplication

\tilde{X}(f,n)=X(f,n)M_{s*}(f,n)

This latter approach is somewhat analogous to using a time-varying Wiener filter in the case of X(f,n) representing the spectra energy (e.g., squared magnitude of the STFT).

If should also be understood that yet other ways of separating a desired signal from the acquired signals may be based on the estimated decomposition. For example, rather than identifying a particular desired signal, one or more undesirable signals may be identified and their contribution to X(f,n) “subtracted” to form an enhanced representation of the desired signal.

Furthermore, as introduced above, the mask information may be used in directly estimating spectrally-based speech recognition feature vectors, such as cepstra, using a “missing data” approach (see, e.g., Kuhne et al., “Time-Frequency Masking: Linking Blind Source Separation and Robust Speech Recognition,” in Speech Recognition, Technologies and Applications (2008)). Generally, such approaches treat time-frequency bins in which the source separation approach indicates the desired signal is absent as “missing” in determining the speech recognition feature vectors.

In the discussion above of estimation of the source and direction structured representation of the signal distribution, the estimates may be made independently for different utterances and/or without any prior information. In some embodiments, various sources of information may be used to improve the estimates.

Prior information about the direction of a source may be used. For example, the prior distribution of a speaker relative to a smartphone, or a driver relative to a vehicle-mounted microphone, may be incorporated into the re-estimation of the direction information (e.g., the q(d|s) terms), or by keeping these terms fixed without re-estimation (or with less frequent re-estimation), for example, at being set at prior values. Furthermore, tracking of a hand-held phone's orientation (e.g., using inertial sensors) may be useful in transforming direction information of a speaker relative to a microphone into a form independent of the orientation of the phone. In some implementations, prior information about a desired source's direction may be provided by the user, for example, via a graphical user interface, or may be inherent in the typical use of the user's device, for example, with a speaker being typically in a relatively consistent position relative to the face of a smartphone.

Information about a source's spectral prototypes (i.e., qₛ(f|z)) may be available from a variety of sources. One source may be a set of “standard” speech-like prototypes. Another source may be the prototypes identified in a previous utterance. Information about a source may also be based on characterization of expected interfering signals, for example, wind noise, windshield wiper noise, etc. This prior information may be used in a statistical prior model framework, or may be used as an initialization of the iterative optimization procedures described above.

In some implementations, the server may provide feedback to the client device that aids the separation of the desired signal. For example, the user's device may provide the spectral information X (f,n) to the server, and the server through the speech recognition process may determine appropriate spectral prototypes qₛ(f|z) for the desired source (or for identified interfering speech or non-speech sources) back to the user's device. The user's device may then use these as fixed, as prior estimates, or initializations for iterative re-estimation.

It should be understood that the particular structure for the distribution model, and the procedures for estimation of the components of the model, presented above are not the only approach. Very generally, in addition to non-negative matrix factorization, other approaches such as Independent Components Analysis (ICA) may be used.

In yet another novel approach to forming a mask and/or separation of a desired signal the acquired acoustic signals are processed by computing a time versus frequency distribution P(f,n) based on one or more of the acquired signals, for example, over a time window. The values of this distribution are non-negative, and in this example, the distribution is over a discrete set of frequency values f ε [1, F] and time values n ε [1, N]. In some implementations, the value of P(f, n₀) is determined using STFT at a discrete frequency f in the vicinity of time t₀ of the input signal corresponding to the n₀^{th} analysis window (frame) for the STFT.

In addition to the spectral information, the processing of the acquired signals may also include determining directional characteristics at each time frame for each of multiple components of the signals. One example of components of the signals across which directional characteristics are computed are separate spectral components, although it should be understood that other decompositions may be used. In this example, direction information is determined for each (f,n) pair, and the direction of arrival estimates on the indices as D(f,n) are determined as discretized (e.g., quantized) values, for example d ε [1,D] for D (e.g., 20) discrete (i.e., “binned”) directions of arrival.

For each time frame of the acquired signals, a directional histogram P(d|n) is formed representing the directions from which the different frequency components at time frame n originated from. In this embodiment that uses discretized directions, this direction histogram consists of a number for each of the D directions: for example, the total number of frequency bins in that frame labeled with that direction (i.e., the number of bins f for which D(f,n)=d. Instead of counting the bins corresponding to a direction, one can achieve better performance using the total of the STFT magnitudes of these bins (e.g., P(d|n)∝Σ_{f:D(f,n)=d} P(f|n)), or the squares of these magnitudes, or a similar approach weighting the effect of higher-energy bins more heavily. In other examples, the processing of the acquired signals provides a continuous-valued (or finely quantized) direction estimate D(f,n) or a parametric or non-parametric distribution P(d|f,n), and either a histogram or a continuous distribution P(d|n) is computed from the direction estimates. In the approaches below, the case where P(d|n) forms a histogram (i.e., values for discrete values of d) is described in detail, however it should be understood that the approaches may be adapted to address the continuous case as well.

The resulting directional histogram can be interpreted as a measure of the strength of signal from each direction at each time frame. In addition to variations due to noise, one would expect these histograms to change over time as some sources turn on and off (for example, when a person stops speaking little to no energy would be coming from his general direction, unless there is another noise source behind him, a case we will not treat).

One way to use this information would be to sum or average all these histograms over time (e.g., as P̅(d)=(1/N)ΣₙP (d|n)). Peaks in the resulting aggregated histogram then correspond to sources. These can be detected with a peak-finding algorithm and boundaries between sources can be delineated by for example taking the mid-points between peaks.

Another approach is to consider the collection of all directional histograms over time and analyze which directions tend to increase or decrease in weight together. One way to do this is to compute the sample covariance or correlation matrix of these histograms. The correlation or covariance of the distributions of direction estimates is used to identify separate distributions associated with different sources. One such approach makes use of a covariance of the direction histograms, for example, computed as

Q(d₁,d₂)=(1/N)Σₙ(P(d₁|n)P̅d₁))(P(d₂|n)P̅d₂))

where P̅(d)=(1|N)ΣₙP(d|n), which can be represented in matrix form as

Q=(1/N)Σₙ(P(n)P̅)(Pn)P̅)^{T}

where P(n) and P̅ are D-dimensional column vectors.

A variety of analyses can be performed on the covariance matrix Q or on a correlation matrix. For example, the principal components of Q (i.e., the eigenvectors associated with the largest eigenvalues) may be considered to represent prototypical directional distributions for different sources.

Other methods of detecting such patterns can also be employed to the same end. For example, computing the joint (perhaps weighted) histogram of pairs of directions at a time and several (say 5—there tends to be little change after only 1) frames later, averaged over all time, can achieve a similar result.

Another way of using the correlation or covariance matrix is to form a pairwise “similarity” between pairs of directions d₁ and d₂. We view the covariance matrix as a matrix of similarities between directions, and apply a clustering method such as affinity propagation or k-medoids to group directions which correlate together. The resulting clusters are then taken to correspond to individual sources.

In this way a discrete set of sources in the environment is identified and a directional profile for each is determined. These profiles can be used to reconstruct the sound emitted by each source using the masking method described above. They can also be used to present a user with a graphical illustration of the location of each source relative to the microphone array, allowing for manual selection of which sources to pass and block or visual feedback about which sources are being automatically blocked.

In another embodiment, input mask values over a set of time-frequency locations that are determined by one or more of the approaches described above. These mask values may have local errors or biases. Such errors or biases have the potential result that the output signal constructed from the masked signal has undesirable characteristics, such as audio artifacts.

### Source Separation According to Neural Network (NN) NTF

NN NTF is based on recognition that the NTF method for acoustic source separation described above can be viewed as a composite model in which each acoustic source is modeled via an NMF decomposition and these sources are combined according to an outer model that takes into account direction, itself a form of NMF. By appropriate rearrangement of the update equations, the inner NMF model can be seen as a sort of denoiser: at each iteration the outer model posits a magnitude spectrogram for each source based on previous iterations, the noisy input data, and direction information, and then the inner NMF model attempts to project the posited magnitude spectrogram onto the space of matrices with a fixed nonnegative rank Z and returns to the outer model an iterate approximating this projection.

According to the inner NMF source model, real acoustic sources do not have arbitrary spectra. Instead, the spectrum in each time frame is a non-negative weighted combination of some small number (e.g. Z=50) of prototype spectra. The non-negativity constraint rules out the destructive interference and is mostly justified based on empirical results.

The NMF model is powerful, but also extremely flexible, allowing for the modeling of many speech as well as non-speech noise sources because it incorporates almost no information about the sound. For example it does not enforce any of the temporal continuity or harmonic structure observed in speech.

By replacing the projection onto non-negative rank Z matrices with an operation that models projection onto realistic voice spectra, the structure of speech may be incorporated, improving separation quality. Also, by modeling only one source in the environment in a speech-specific way and modeling the rest of the sources with some other model, e.g. a more generic model such as NMF, the source selection problem of deciding which of the separated sources corresponds to voice is solved automatically.

In the following, NN NTF is described with reference to a sound signal being a voice/speech. However, NN NTF teachings provided herein allow modelling and separating any acoustic sources, not only voice/speech.

Further, some exemplary embodiments described herein refer to Deep NN (DNN). However, teachings provided herein are equally applicable to embodiments where other kinds of NN may be used, such as e.g. recurrent neural nets (RNN) or long short-term memory (LSTM) nets, as well as to embodiments where any other models are applied, e.g. any regression method designed and/or trained to predict or estimate contributions of a particular acoustic source of interest.

First, the basic mode equations of NTF are summarized again, where model may be represented as:

q(f,n,d,z,s):=q(s)q(f|s,z)q(n,z|s)q(d|s)=q(d,s)q(f,z|s)q(n|s,

and updates may be represented as:

$$\begin{matrix}{q}^{1} ( d , s ) = {q}^{0} ( d , s ) {\sum }_{f , n} \underbrace{\frac{{p}^{obs} ( f , n , d )}{{q}^{0} ( f , n , d )}}_{call this ρ ( f , n , d )} {q}^{0} ( f , n \vert s ) = {q}^{0} ( d , s ) {\sum }_{f , n} ρ ( f , n , d ) {q}^{0} ( f , n \vert s ) , & ( 1 ) \\ {q}^{1} ( f , z , s ) = {q}^{0} ( f , z \vert s ) {\sum }_{n , d} ρ ( f , n , d ) {q}^{0} ( d , s ) {q}^{0} ( n \vert s , z ) , & ( 2 ) \\ {q}^{1} ( n , z , s ) = {q}^{0} ( n \vert s , z ) {\sum }_{f , d} ρ ( f , n , d ) {q}^{0} ( d , s ) {q}^{0} ( f , z \vert s ) . & ( 3 )\end{matrix}$$

where

q⁰(f,n,z|s):=q⁰(f,z|s)q⁰(n|s,z)

Update equation (1) is left as is. Then let

π⁰(f,n,s):=Σ_{d}ρ(f,n,d)q⁰(d,s)q⁰(f,n|s)

and note that by substituting the definition of p we can verify that n° is a probability distribution. Then update equations (2) and (3) may be re-written as

$$\begin{matrix}{q}^{1} ( f , z , s ) = {\sum }_{t} \frac{{π}^{0} ( f , n , s )}{{q}^{0} ( f , n \vert s )} {q}^{0} ( f , n , z \vert s ) , & ( 4 ) \\ {q}^{1} ( n , z , s ) = {\sum }_{f} \frac{{π}^{0} ( f , n , s )}{{q}^{0} ( f , n \vert s )} {q}^{0} ( f , n , z \vert s ) . & ( 5 )\end{matrix}$$

Since the right hands of equations (1), (2), and (3) contain q¹ (f, z, s) and q¹ (n, z, s) through their conditional distribution when conditioned on s, by conditioning equations (4) and (5) on s the following equivalent updates are obtained:

$$\begin{matrix}{q}^{1} ( f , z \vert s ) = {\sum }_{n} \frac{{π}^{0} ( f , n \vert s )}{{q}^{0} ( f , n \vert s )} {q}^{0} ( f , n , z \vert s ) , & ( 6 ) \\ {q}^{1} ( n , z \vert s ) = {\sum }_{z} \frac{{π}^{0} ( f , n \vert s )}{{q}^{0} ( f , n \vert s )} {q}^{0} ( f , n , z \vert s ) . & ( 7 )\end{matrix}$$

For each fixed source s, these are exactly one step of the EM update equations to learn an NMF decomposition π⁰(f,n|s)≈Σ_{z} q(f,z|s)q(n|s,z). The only difference from standard NMF is that the target distribution π⁰(f,n|s) is changing at each iteration of the outer NMF loop.

The following definitions may be provided:

q¹(f,n,z|s):=q¹(f,z|s)q¹(n|s,z)

q¹(f,n|s):=Σ_{z}q¹(f,n,z|s)

So q¹(f, n|s) is an NMF approximation of π⁰ (f, n|s) with rank at most Z.

The NMF portion of the updates may then be hidden to obtain:

$$\begin{matrix}{q}^{1} ( d , s ) = {q}^{0} ( d , s ) {\sum }_{f , n} ρ ( f , n , d ) {q}^{0} ( f , n \vert s ) , & ( 8 ) \\ {π}^{0} ( f , n , s ) = {\sum }_{d} ρ ( f , n , d ) {q}^{0} ( d , s ) {q}^{0} ( f , n \vert s ) & ( 9 ) \\ {q}^{1} ( f , n \vert s ) = {Projection}_{NMF [ Z ]} \{ {π}^{0} ( f , n \vert s ) \} for each \text{source} s . & ( 10 )\end{matrix}$$

Equations (8)-(10) do not contain q(f, z|s) and q(n|s, z) as these terms are now hidden in the projection step, and in particular a warm start approach to the projection step. Experimental results show that the algorithm computes a result of equal quality, albeit more slowly, if instead of running one iteration of the NMF updates from a warm start within each outer NTF iteration, one starts with random initial conditions and runs the NMF updates until convergence within each NTF iteration.

Now suppose that instead of the NTF model, a model of the following form is fitted:

$${p}^{obs } ( f , n , d ) \approx {\sum }_{s} q ( d , s ) q ( f , n \vert s ) . \qquad ( 11 )$$

This is referred to as Directional NMF because it can be viewed as a plain NMF decomposition of an D×FN matrix into a D×S matrix times an S×FN matrix. This is a decomposition which does not enforce any structure on the magnitude spectrograms of the sources. In fact, the EM updates reduce exactly to (8)-(10) but with the projection replaced by the identify transformation

q¹(f,n|s)=π⁰(f,n|s).

Instead of the identity or projection onto the space of matrices with an NMF decomposition of a particular rank, it is possible to apply any other sort of denoising operation to produce q¹(f, n|s) from π⁰ (f, n|s), including different operations for different sources s. For example, a DNN may be trained to transform speech with background noise into clean speech, or speech with the kind of artifacts typical of NTF into clean speech, or some combination of these, and use this DNN in place of the projection in (10).

There are many classes of neural nets that could be trained for this purpose, depending on the desired complexity and what kind of structure is of interest (i.e. which kind of audio signal is to be separated). For example, each time frame of the output could be predicted based on the corresponding time frame of the input, or based on a window of the input. Alternatively or additionally, in order to capture longer range interactions, other types of neural net models may be learned, such as recurrent neural nets (RNN) or long short-term memory (LSTM) nets. Further, nets may be trained to be specific to a single speaker or language, or more general, depending on the training data chosen. All these nets could be integrated into a directional source separation algorithm by the procedure discussed above.

Similar techniques may be applied to learn a model for background noise, e.g. application-specific background noise such as e.g. noises in and around a car, or an NMF model or the trivial Directional NMF model may be used for background source(s).

One feature of the NMF updates is that they converge to a fixed point: repeatedly applying them eventually leads to little or no change and the result is typically a good approximation of the matrix which was to be factored. Neural nets need not have this property, so it may be helpful to structure the training data to induce this idempotence. For example, some training examples may be provided that have clean speech as the input and target.

In an embodiment, a neural net may be softened by taking a step from the input in the direction of the output, e.g. by taking

q¹(f,n|s)=απ(f,n|s)+(1−α)DNN{π(f,n|s)}

for some a close to one.

### Basic NTF Vs NN NTF

As described above, basic NTF is based on using some side information such as e.g. direction information in order to perform source separation. This stems from the fact that generic NMF source model is too unstructured and, therefore, other cues, such as e.g. direction cues, are needed to suggest which spectral prototypes to group together into sources. In contrast to basic NTF, NN NTF approach does not have to use direction data to perform source separation because the NN source model has enough structure to group time-frequency bins into a speech-like source (or any other acoustic source modeled by NN NTF) based on its training data. However, when direction data is available, using it will typically improve separation quality and may reduce convergence time.

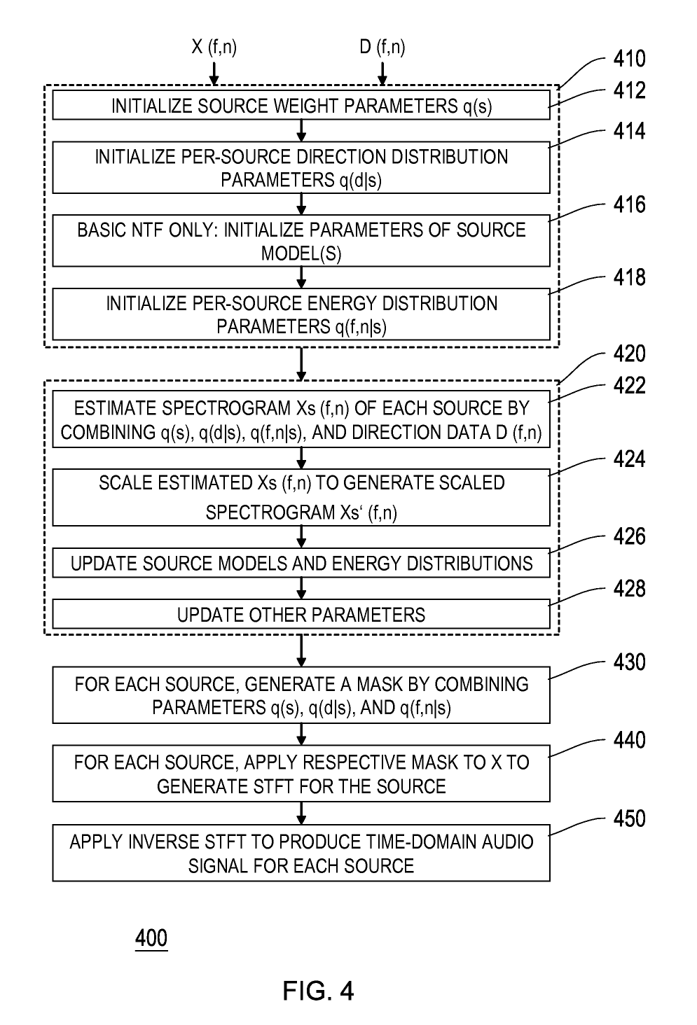

FIG. 4 is a diagram illustrating a flow chart 400 of method steps leading to separation of acoustic sources using direction data, according to various embodiments of the present disclosure. In particular, FIG. 4 summarizes steps of basic NTF and NN NTF approaches described above for performing signal separation, e.g. as a part of step 230 of the method illustrated in FIG. 2, using direction data D(f,n). While FIG. 4 puts forward steps which could be performed in both basic NTF and NN NTF approaches, discussion below also highlights the differences between the two.

The steps of the flow chart 400 may be performed by one or more processors, such as e.g. processors or processing units within client devices 110 and 602 and/or processors or processing units within servers 150 and 604 described herein. However, any system configured to perform the methods steps illustrated in FIG. 4 is within the scope of the present disclosure. Furthermore, although the elements are shown in a particular order, it will be understood that particular processing steps may be performed by different computing devices in parallel or in a different order than that shown in the FIGURE.

One goal of the flow chart 400 is to separate an audio mixture into component sources through the use of side information such as one or more models of different acoustic sources (e.g. it may be desirable to separate a particular voice from the rest of audio signals) and direction information described above. To that end, the method 400 may need to have access to one or more of the following: number of acoustic sources, model type for each acoustic source, hyper parameters for source models, e.g. number of z values or prototypes to use in the NMF case, which denoiser to use in the NN case, microphone array geometry, and hyper parameters for directionality, e.g. whether and/or how to discretize directions, parametric form of allowed direction distributions.

Prior to the method 400, magnitude data X(f,n) and direction data D(f,n) is collected, e.g. in one of the manners described above with reference to step 220.

In addition, NN NTF approach is based on training an NN source model for one or more acoustic sources that the method 400 is intended to identify. This training step (not shown in FIG. 4) is also typically done prior to running of the method 400 because it is time-consuming, computationally-intensive, and may only be performed once and the results may then be re-used each time the method 400 is run. The NN training step is described in greater detail below in order to compare and contrast it to the source model initialization step of the basic NTF.

The source separation method 400 may begin with an initialization stage 410. Stage 410 may include several initialization steps, at least some of which may occur in any order (i.e. sequentially) or in an overlapping order (i.e. completely or partially at the same time). Typically, such an initialization is done randomly, however, initialization in any manner as known to people skilled in the art is within the scope of the present application. As part of the initialization, in step 412, source weight parameters q (s) are initialized, where relative total energies are assigned to each one of the sources, thereby indicating contribution of each source in relation to other sources. In step 414, per-source direction distribution parameters q(d|s) are assigned to each source, for all sources s and directions d.

Steps 412 and 414 are equally applicable to both basic NTF and NN NTF approaches. The approaches begin to differ in step 416, where, applicable to basic NTF only, one or more source models to be used in the rest of the method are initialized. Logically speaking, the step of initializing the source models in basic NTF is comparable to the step of training the NN source models in NN NTF, in that, as a result of performing this step, a model for a particular acoustic source is set up. In practice, however, there are significant differences, some of which are described below.

For basic NTF, the step of initializing source model(s) parameters is typically performed each time source separation process 400 begins. The step is based on recognition that, for each acoustic source that might be expected in a particular environment, a type of a “source model” may be chosen, depending on what the source is intended to model (e.g. two acoustic sources may be expected: one—voice and one—background noise). As described above for basic NTF, each acoustic source has an NMF source model, which model is quite generic, but nevertheless more restrictive than assuming that the source can produce any spectrogram. Parameters of such an NMF source model (for each source) that are initialized in step 416 include e.g. a prototype frequency distribution q (f|s, z) and time activations q (n, z|s) which indicate when the prototypes are active.

The basic version of an NN source model has no such parameters. It is intended that the method 400 for NN NTF would use an NN source model trained to a particular type of acoustic source, e.g. voice, to separate that acoustic source from the mixture.

Training an NN source model, also referred to as “training a denoiser,” refers to training a model to predict a spectrogram (i.e. time-frequency energy distribution, typically magnitude of an STFT) of a particular acoustic source (e.g. speech) from a spectrogram of a mixture of speech and noise. A variety of models (e.g. DNN, RNN, etc.) could be trained by a variety of means, all of which are within the scope of the present disclosure. Such training approaches typically depend on providing a lot of corresponding pairs of clean and noisy data, as known to people skilled in the art and, therefore, not described here.

The type of noise which the denoiser is trained to remove/keep may be chosen freely, depending on a particular implementation of the source separation algorithm. For example, a particular implementation may expect specific types of background noise and, therefore, mixtures with these types of noise may be used as training examples. In another example, when a particular implementation intends to separate speech from other noises, training may further be focused on various aspects such as e.g. speech from a wide variety of speakers, a single speaker, a specific category (e.g. American-accented English speech), etc. depending on the intended application. One could similarly train an NN model to predict background noise from a mixture of speech and noise and use this as an NN background noise model.

In context of NN NTF, step 416 may be comparable to training of an NN model to predict a particular acoustic source from a mixture of sounds. Unlike step 416 that is performed every time the separation method 400 is run, the NN model training may be performed once and then re-used every time the separation method is run. This difference arises from the fact that training an NN model typically takes an enormous amount of training data and computational resources, e.g. the order of terabytes and weeks on a cluster and/or CPU. The result is then a trained network which may be viewed as a distilled version of the training data taking up e.g. on the order of maybe megabytes (for embedded systems, the amount of data in an NN model is limited by the size of the embedded memory, in cloud-based system, the amount of data may be larger). Typically, the NN training is performed well in advance, on a system that is much more powerful than that needed for running the separation method itself, and then the learned NN coefficients are encoded onto a memory of the system that will be running the separation method, to be loaded from the memory at run time. The basic NTF source model (NMF source model), on the other hand, is initialized randomly at run time, which amounts to generating perhaps on the order of 1e4 to 1e6 random numbers and is quite fast.

In an embodiment, the method 400 may use a combination of one or more NN source models and one or more basic NMF source models, e.g. by using an NN source model to capture the acoustic source for which the model is trained (e.g. voice) and to use another source model, such as e.g. NMF, to capture everything else (e.g. background noise).

The method may then proceed to step 418, where the source models are used to initialize per-source energy distribution q(f, n|s). This is also where the basic NTF and NN NTF approaches differ. In the case of basic NTF, this step involves assigning per-source energy distribution

$$q ( f , n \vert s ) = {\sum }_{z} q ( f \vert z , s ) q ( n , z \vert s )$$

as described above. In case of NN NTF, per-source energy distribution of an NN source model could be initialized randomly or by some other scheme, such as e.g. running the NN on X (i.e. the collected magnitude data).

The method may then proceed to the iteration stage 420, which stage comprises steps 422-428.

In step 422 of the iteration stage 420, parameters q(s), q(d|s), per source energy distributions q(f, n|s), and direction data D(f,n) are combined to estimate spectrogram Xs(f,n) of each source. Typically, such a spectrogram will be very wrong in early iterations but will converge to a sensible spectrogram later on.

In step 424 of the iteration stage 420, for each time-frequency bin, the estimated spectra Xs (f,n) are scaled so that the sum over all sources adds up to X(f,n). The scaling is done per bin. The result may be referred to as Xs′(f,n). Steps 422 and 424 are performed substantially the same for both, basic NTF and NN NTF, approaches.

In step 426 of the iteration stage 420, source models and energy distributions are updated based on the scaled estimated spectra of step 424. This is where the basic NTF and NN NTF differ again. In case of a NMF source model (i.e. basic NTF), step 426 involves updating the source model parameters and then re-computing q (f,n|s) as done in step 418. In case of an NN model, step 426 involves running the NN model (or whichever other model may be used) with input Xs′(f,n) and referring to the output as “q(f,n|s).”

In step 428 of the iteration stage 420, which, again, may be performed substantially the same for both, basic NTF and NN NTF, approaches, other model parameters may be updated. To that end, e.g. q(s) may be updated to reflect relative total energy in the different acoustic sources and q(d|s) may be updated to be the weighted histogram given by weighting the directions D(f,n) according to weights Xs′(f,n). In some embodiments, q (d|s) may then be modified to remain within a preselected parametric family, thereby sharing some statistical strength between different parts of the model and avoiding over fitting.

Steps 422-428 of the iteration stage 420 are iterated for a number of times, e.g. for a certain number of iterations (either predefined or dynamically defined), until one or more predefined convergence conditions is(are) satisfied, or until a command is received indicating that the iterations are to be stopped (e.g. as a result of receiving user input to that effect).

Once the iterations are finished, the method may then proceed to stage 430 where values of the model parameters q(s), q(d|s), and q(f,n|s) available after the iteration stage 420 are used to generate, for each source of interest, a respective mask for identifying contributions from the source to the characteristics X. In an embodiment, such a mask may be generated by carrying out steps similar to steps 422 and 424, but optionally without incorporating the direction portions, to produce estimated separated spectra. One reason for leaving out direction data in stage 430 may be to limit the use of directional cues to learning the rest of the model, in particular steps of the iteration stage 420, without overemphasizing the noisy directional data in the final output of the method 400. The outputs of the iteration stage 420, i.e. parameters q(s), direction distribution q(d|s), and per-source energy distributions q(f, n|s), are provided as an input to step 430, where these outputs are combined to estimate a new spectrogram Xs(f,n) of each source. Then, for each time-frequency bin, the fraction Mₛ (f,n)=Xₛ(f,n)/ΣₛXₛ(f,n) of mass in the bin due to each source is computed, similar to how a mask per source is described above.

For each source s, the quantities Mₛ(f,n) may be viewed as soft masks because their value in each time-frequency bin is a number between zero and one, inclusive. In other implementations, one may modify the mask, such as by applying a threshold to it to produce a hard mask, which only takes values zero and one, and typically has the effect of increasing perceived separation but may also cause artifacts. In some embodiments, masks may be modified by other nonlinearities. In some embodiments, the values of a soft or a hard mask may be softened by reducing their range from [0,1] to some smaller subset, e.g. [0.1, 0.9], to have the effect of decreasing artifacts at the expense of decreased perceived separation.

The method may then proceed to step 440 where an estimated STFT is generated for each source by applying a mask for the source to the time-dependent spectral characteristics. In one embodiment, step 440 may be implemented by multiplying the mask Mₛ(f,n) by the STFT of the noisy signal to get the estimated STFT for the sources.

In step 450, inverse STFT may be applied to the outcome of step 440 to produce time-domain audio for each source (or for a desired subset thereof).

Similar to steps 412, 414, 422, 424, and 428, steps 430, 440, and 450 may be performed substantially the same for both, basic NTF and NN NTF, approaches.

As the foregoing description illustrates, differences between basic NTF and NN NTF model reside in steps 416, 418, and 426. In the basic NTF case, when all sources have NMF source models, the method is symmetric with respect to sources. The symmetry is broken by the random initialization, but one still does not know which separated source corresponds to e.g. voice vs. background noise. In the NN source model case, the expectation is that e.g. a model trained to isolate voice will end up corresponding to a voice source, since it is being nudged in that direction at each iteration, while the other source will end up modeling background noise. Therefore, the NN source model solves not only the source separation but also the source selection problem-selecting which separated source is the desired one (the voice, in most applications). In an embodiment, computational resources may be saved by only computing the inverse STFT of the desired source (e.g. voice) and passing only the resulting single audio stream on as the output of the method 400.

Incorporating a model of an acoustic source that is data-driven, such as an NN model, rather than a generic model not specific to any acoustic source, such as an NMF model, may improve quality of the separation by e.g. decreasing the amount of background which remains in the voice source after separation and vice versa. Furthermore, it enables source separation without using direction data. To that end, steps of FIG. 4 described above for the NN NTF approach may be repeated without the use of directional data mention therein. In the interests of brevity, steps omitting the direction data are not repeated here.

Combination of Basic NTF with NN Source Model(s)

As described above, basic NTF may be combined with using one or more NN source models by e.g. using an NN source model to capture the acoustic source for which the model is trained (e.g. voice) and to use the NMF source model of basic NTF to capture everything else (e.g. background noise).

Another way to benefit from the use of NN model(s) is by applying the NN model(s) to the input magnitude data X. Such an implementation, referred to herein as an “NTF with NN redux,” is described below for the example of using an NN model that is trained to recognize voice from a mixture of acoustic signals. The term “redux” is used to express that such an implementation benefits, in a reduced form (hence, “redux”) from the incorporation of an additional model such as an NN source model.

Source Separation According to Basic NTF with NN Redux

The basic NTF algorithm described above is based on using a, typically discretized, direction estimate D (f,n) for each time-frequency bin, where the estimates are used to try to group energy coming from a single direction together into a single source, and, if the parametric family technique mentioned in step 428 above is used, to a lesser extent group energy from close directions into a single source. The NTF with NN redux approach is based on an insight that an NN model, or any other model based on regression or classification analysis, may be used to analyze the input X (f,n) and provide cues G (f,n) which are value(s) of a multi-valued property representing value(s) of the property the mass in that bin represents, e.g. which type of source the mass in the bin is believed to correspond to, such as e.g. a particular voice. These cues can be used in the same way as the directionality cues to try to group together time-frequency bins which are likely to contain contributions sharing the same property and conclude that these bins comprise contributions generated by a single source of interest (e.g. voice). Time-frequency bins which are not likely to contain such contributions may be grouped together into another source (e.g. everything else besides the voice). Thus, the NTF with NN redux method may proceed in the same manner as the basic NTF described above, in particular it would use the NMF source models as described above, except that everywhere where direction terms D (f,n) and q (d|s) are used, corresponding contributions from G (f,n) and a new term q (g|s) would be used in place of the direction terms.

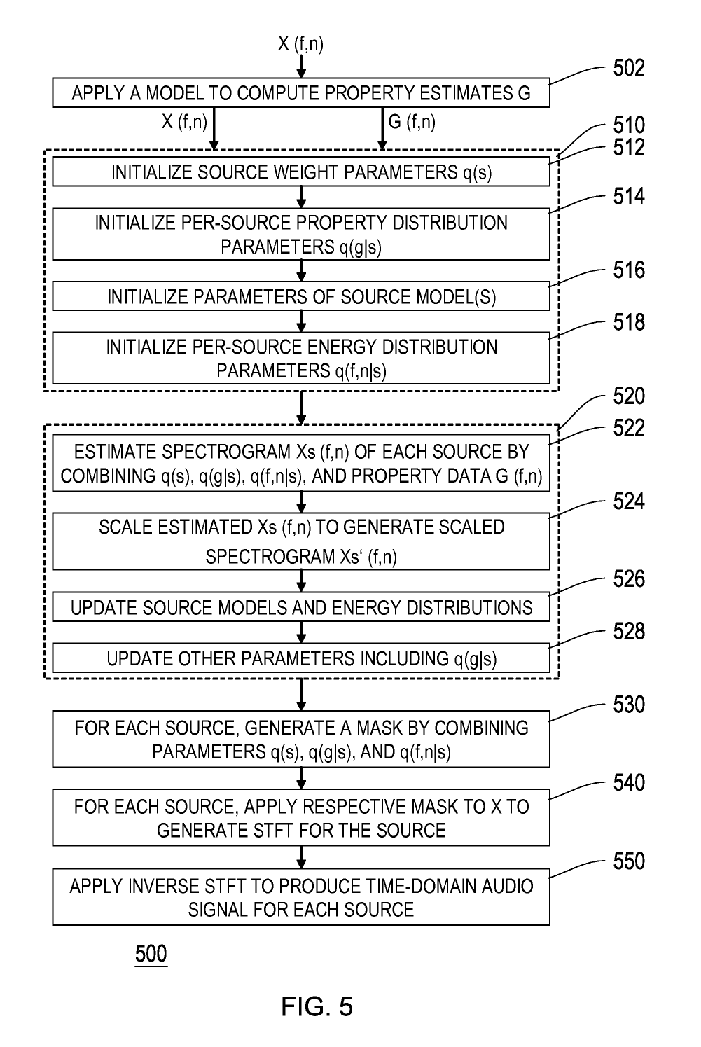

FIG. 5 is a diagram illustrating a flow chart 500 of method steps leading to separation of acoustic sources using property estimates G, according to an embodiment of the present disclosure. In particular, FIG. 5 summarizes steps of a basic NTF approach described above for performing signal separation, e.g. as a part of step 230 of the method illustrated in FIG. 2, using property estimates G(f,n).

The steps of the flow chart 500 may be performed by one or more processors, such as e.g. processors or processing units within client devices 110 and 602 and/or processors or processing units within servers 150 and 604 described herein. However, any system configured to perform the methods steps illustrated in FIG. 5 is within the scope of the present disclosure. Furthermore, although the elements are shown in a particular order, it will be understood that particular processing steps may be performed by different computing devices in parallel or in a different order than that shown in the FIGURE.

Similar to the method 400, one goal of the flow chart 500 is to separate an acoustic mixture into component sources through the use of side information. To that end, similar to the method 400, the method 500 may need to have access to one or more of the following: number of acoustic sources, model type for each acoustic source, hyper parameters for source models, e.g. number of z values or prototypes to use in the NMF case, which denoiser to use in the NN case, microphone array geometry, and hyper parameters for directionality, e.g. whether and/or how to discretize directions, parametric form of allowed direction distributions.

Prior to the method 500, magnitude data X(f,n) is collected, e.g. in one of the manners described above with reference to step 220.

In addition, NTF with NN redux approach is based on using a model, such as e.g. an NN model, trained and/or designed to compute property estimates G of a predefined property for the spectral characteristics X. Such training may be done prior to running the method 500, and the resulting models may then be re-used in multiple instances of running the source separation algorithm of FIG. 5. Discussions provided for an NN model with reference to FIG. 4 are applicable here and, therefore, in the interests of brevity, are not repeated.

The source separation method 500 may begin with step 502 where magnitude data X (f,n) is provided as an input to a model, such as e.g. a NN model. The model is configured to compute property estimates G of a predefined property, so that each time-frequency bin being considered (some may be not considered because they are e.g. too noisy) is assigned one or more property estimates of the predefined property so that the one or more property estimates correspond to the mass in the bin. In other words, each time-frequency bin being considered would have a corresponding one or more likelihood estimates, where likelihood estimate indicates how likely it is that the mass X(f,n) in that bin corresponds to a certain value of the property. For example, if the property is “direction,” the value could be e.g. “north by northeast”, “southwest”, or “perpendicular the plane of the microphone array.” In another example, if the property is “speech-like,” then the value could be e.g. “yes”, “no”, “probably.” In yet another example, if the property is something more specific like a “type of speech,” then the values could be “male speech”, “female speech”, “not speech”, “alto singing”, etc. Any variations and approaches for quantizing the possible values of a property estimate are within the scope of the present disclosure.

As a result of applying the model in step 502, property estimates G(f,n) may be provided to the NTF model, as shown with G(f,n) being provided from step 502 to an initialization stage 510. In addition, the magnitude data X is provided as well (as also shown in FIG. 5).

The initialization stage 510 is similar to the initialization stage 410 for the basic NTF except that property estimates are used in place of direction estimates. Discussions provided above for steps 412, 416 and 418 for the NTF model are applicable to steps 512, 516, and 518, and therefore, are not repeated here. In step 514, per-source property distribution parameters q(g|s) are assigned to each source, for all sources s and property estimates G.

After the initialization stage 510, the method 500 may then proceed to the iteration stage 520, which stage comprises steps 522-528.

In step 522 of the iteration stage 520, parameters q(s), q(g|s), per source energy distributions q(f, n|s), and property estimates G(f,n) are combined to estimate spectrogram Xs(f,n) of each source. Typically, such a spectrogram will be very wrong in early iterations but will converge to a sensible spectrogram later on.

Steps 524, 528, 530, 540, and 550 are analogous to steps 424, 428, 430, 440, and 450 described above for the basic NTF except that instead of direction distribution q(d|s) property distribution q(g|s) is used, and, in the interests of brevity, are not repeated here.

In comparison with the basic NTF, the NTF with NN redux approach may provide increased separation quality. Furthermore, despite the fact that generic NMF models may be used for source separation, the NTF with NN redux approach solves the source selection problem because the final iterates of the term q (g|s) provide information about which source is the source of interest (e.g. which source is voice). It may also be considered to be advantageous to the NN NTF approach described above because the NN only needs to be run once (in step 502), as opposed to doing it in each iteration (in step 426), thus reducing demands on computational and memory resources of a system running the method.

Source Separation According to NN NTF with NN Redux

Not only the basic NTF approach described above, but also the NN NTF approach described above may benefit from applying the NN redux as described above for the basic NTF. Such an approach is referred to herein as “NN NTF with NN redux” indicating that it is a combination of the NN NTF approach with the NN redux approach described herein. Similar to basic NTF with NN redux, the NN NTF with NN redux is also based on an insight that an NN model, or any other model based on regression analysis, may be used to analyze the input X (f,n) and provide cues G (f,n) which are value(s) of a multi-valued property representing value(s) of the property the mass in that bin represents, e.g. which type of source the mass in the bin is believed to correspond to, such as e.g. a particular voice. The manner in which such cues are used and incorporated into an NTF model is similar to the one described above with reference to FIG. 5, except that this time the NTF model is the NN NTF model as described above. Therefore, in the interests of brevity, these discussions are not repeated here.

It should be noted that in an NN NTF with NN redux approach an NN model is used in two contexts. One time an NN model is used in a step where the magnitude data X is provided as an input to such a model that is then configured to compute property estimates G of a predefined property for the different bins of data X (in a step analogous to step 502 described above). Another time an NN model is used as a part of performing the iterations of the NTF model, where the iterations include running the NN model to separate contributions of an acoustic source of interest from the audio mixture. In some embodiments, these two models may be the same model, e.g. a model configured to identify a particular voice. However, in other embodiments, these two models may be different.

### Streaming NTF

Large amounts of data acquired by an array of one or more acoustic sensors create additional challenges to performing source separation because running the models on large amounts of data requires large computational and memory resources and may be very time consuming. These challenges become especially pronounced in implementations where sensor data changes quickly.

An aspect of the present disclosure that aims to reduce or eliminate the problems associated with processing quickly changing large sets of data is based on an insight that running a full analysis each time sensor data changes is at best inefficient, and more likely impossible. Such an aspect of the present disclosure offers a method, referred to herein as a “streaming NTF” method, enabling one or more processing units to identify and process incremental changes to an NTF model rather than re-processing the entire model. Such incremental stream processing provides an efficient and fast manner for performing source separation on quickly changing data.

The streaming NTF method described herein is applicable to any models for source separation such as e.g. NMF model as known in the art or any of the approaches described herein, such as the basic NTF, NN NTF, basic NTF with NN redux and NN NTF with NN redux and any combinations of these approaches. Moreover, while the streaming NTF method is described herein with reference to source separation of a particular acoustic source of interest from a mixture of audio signals, the method is equally applicable to doing source separation on other signals, such as e.g. electromagnetic signals, as long as an NTF or NMF model is used. For example, one application of the streaming NTF method described herein could be in tracking heart rate from photo-sensors on a person's wrist in the presence of motion artifacts. More generally, applications include any source separation tasks in which a structured signal of interest is corrupted by one or more structured interferers.

First, a theoretical framework for the streaming NTF approach is described, illustrating how batch mode NTF (i.e. NTF that requires its full input over all time to begin processing) may be adapted to a streaming version. Such a streaming NTF may offer flexible latency/quality tradeoffs and fixed memory requirements independent of stream length.

The basic mode equations of NTF summarized above (model and updates in formulas (1)-(3)) are applicable here and, in the interest of brevity are not repeated.

To modify the batch mode updates to produce a streaming mode version, first, the sums over all time in equations (1) and (2) are reinterpreted as sums over time up to the present time frame: n≦N₁. Since q¹(n, z, s) is only updated for time up to the present, equation (3) is evaluated for n≦N₁ as well.

The resulting updates may be run for as many iterations as desired and incorporate new data as time passes by incrementing N₁, initializing q(n=N₁|s, z) based on how much new energy is in the input spectrogram at n=N₁ relative to n<N₁, and iterating the equations some more. The problem with this approach is that the full past ρ(f, n, d) and q0(n|s, z) must be stored to run each iteration, so as more data streams in, the iterations would take proportionally more time and memory. Embodiments of the present disclosure are based on recognition that such an approach would update the time activation factor q¹(n, z, s) over the entire past n≦N₁ at every iteration, but in a streaming source separation application with bounded latency, decisions made before some N₀<N₁ would be fixed and the separated data would already have been output so in a sense revisiting these decisions would be a waste of computational effort.

Therefore, according to the streaming NTF approach, some N₀<N₁ is fixed and N₀≦n≦N₁ is viewed as the present block is being operated on. Then q¹(n, z, s) is only updated for the present block, which means that the update (3) may be run only knowing ρ(f, n, d) for the present block. On the other hand, updates (1) and (2) both still have sums over the entire past. To address this, an approximation can be made where the portions of these sums (including the factor in front of the sum) over n<N₀ are stored in memory and these terms are not updated on each iteration as they technically should be. In this manner, streaming updates are obtained:

$${q}^{1} ( d , s ) = {q}^{old} ( d , s ) + {q}^{0} ( d , s ) {\sum }_{{N}_{0} \leq n \leq {N}_{1} , f} ρ ( f , n , d ) {q}^{0} ( f , n \vert s ) , \\ {q}^{1} ( f , z , s ) = {q}^{old} ( f , z , s ) + {q}^{0} ( f , z \vert s ) {\sum }_{{N}_{0} \leq n \leq {N}_{1} , d} ρ ( f , n , d ) {q}^{0} ( d , s ) {q}^{0} ( n \vert s , z ) , \\ {q}^{1} ( n , z , s ) = {q}^{0} ( n \vert s , z ) {\sum }_{f , d} ρ ( f , n , d ) {q}^{0} ( d , s ) {q}^{0} ( f , z \vert s ) for {N}_{0} \leq n \leq {N}_{1} .$$

In order to properly weight the past against the present block, the invariant that all p's and q's are normalized to be probability distributions is no longer maintained. Instead, X may be computed as in batch mode (e.g. as a noisy magnitude spectrogram weighted by direction estimates) and may be left un-normalized. The invariant that distributions q^{old} sum to whatever value X sums to when all variables are summed out but n is only summed over the past n<N₀ is maintained. The sum of the present terms in each of the first two equations for streaming updates above is then equal to the sum of X with n only summed over the present block. Thus the present and past are weighted against each other in the streaming updates as they are in the input. All the q distributions updated on each iteration may be viewed as implicitly restricted to or, by normalizing, conditioned on N₀≦n≦N₁.

When the streaming updates have run for as many iterations as desired on the present block, the current factorization can be used to compute a time-frequency mask at one time frame (e.g. n=N₀, n=N₁, or an intermediate value depending on the desired latency-accuracy tradeoff) and then this mask may be used to scale the corresponding portion of the noisy input STFT. Applying the inverse FFT to this masked frame and optionally multiplying by a window function yields a frame worth of separated time-domain signal. Since the forward STFT is computed by breaking the time-domain signal into overlapping chunks, the inverse STFT must add together corresponding overlapping chunks. Therefore the frame worth of separated time domain signal is shifted appropriately relative to a buffer of corresponding results from previous stages and added to these. The portion of the buffer for which all relevant STFT frames have been processed is now ready to be streamed out. The remainder of the buffer is saved awaiting more separated frames to add to it.

To continue, the present window may then be shifted by incrementing No and N₁ when a new time frame of input data X is obtained. To maintain the invariants discussed above, the following increment are made:

q^{old}(d,s)+=q⁰(d,s)ρ(f,N₀,d)q⁰(f,N₀|s),

q^{old}(f,z,s)+=q⁰(f,z|s)ρ(f,N₀,d)q⁰(d,s)q⁰(N₀|s,z).

Also, various embodiments of the streaming NTF method may be technically free to reinitialize the q distributions (except q^{old}), but in the interest of saving work and decreasing the number of iterations required on each block, some embodiments may choose to minimize the re-initialization. To do this, in an embodiment, q(d, s) and q(f, z|s) may be kept from the previous block. Alternatively, to avoid local optima, these values may be softened slightly by e.g. averaging with a uniform distribution. For q(n|s, z), one solution could be to remove the n=N₀ portion, and add in a flat n=N₁+1 portion, scaling this against q(n|s, z) for the retained frames N₀+1≦n≦N₁ according to the mass in X in those retained frames vs. the mass at n=N₁+1.

One advantage of the streaming mode version over the batch mode version is that it admits a natural modification to allow it to gradually forget the past and adapt to changing circumstances (e.g. moving sound sources or microphones or changing acoustic environment). All that is needed is to multiply the previous value of q^{old} (in the two equations for q^{old} above) by some discount factor less than 1, e.g. 0.9, before adding the increment term.

To summarize, a streaming mode version of the basic NTF method is described above. The streaming version operates on a moving block of time frames of fixed length N₁−N₀. In various embodiments, several free parameters may influence the performance of the streaming version. For example, the size of the block can be adjusted to trade off accuracy (in the sense of fidelity to the block mode version) with computational burden per iteration, the position within the block at which values are used to compute masks for separation can be adjusted to trade off accuracy with latency, and a discount factor can be adjusted to trade off accuracy with adaptation to changing circumstances.

The streaming mode version of the basic NTF method described above is one particular implementation. From this description a person skilled in the art will realize how to modify the description to produce implementations with e.g. blocks of varying size, blocks which advance multiple frames simultaneously, and blocks which produce multiple frames of output. Such implementations are within the scope of the present application.

Now, a textual outline for the streaming NTF method is presented.

The streaming NTF method is based on maintaining (for processing) a finite block of the recent past, while the distant past is only retained through some summary statistics. This mode of operation has never been used for an NMF/NTF-like algorithm as these algorithms are typically operated in batch mode.

In the streaming NTF method, rather than having a sequence of steps, information is streaming through different interacting blocks, which may in turn be implemented as a series of steps on e.g. one or more processing units, e.g. DSP.

In setting hyperparameters, in various embodiments, either the system carrying out the streaming NTF method or a user is free to decide on a block size for the sliding block, e.g. 10 frames of audio, with the idea that some portion of data (e.g. 10 frames of audio) is maintained, a new portion of data is periodically received, and the oldest portion is eventually removed/deleted. The system or a user is also free to decide on what time frame(s) relative to the block will be used to generate masks for separation. Frames farther in the future correspond to lower latency, while frames further in the past correspond to more iterations, more data incorporated, and a closer match to the batch version.

In an embodiment, an initialization stage of streaming NTF may include steps similar to those described for the stage 410 with reference to FIG. 4 as well as a few extra steps. In comparison with the steps of stage 410, similar initialization steps in context of streaming NTF are modified so that any parameters like q(n|s,z), whose size is the number of time frames of the acquired signal, are now sized to the number of frames in chosen block size. Extra steps include defining a q^{old}(d,s) and q^{old} (f,z,s) in a manner similar to the corresponding q's but which will keep track of the summary of the distant past; these may be initialized to all zeros or to some nonzero values with the effect of biasing the streaming factorization toward the given values. If grouping cues as described in the NN redux method(s) are used, then there will also be a q^{old} (g,s) used substantially the same way as the direction data. If there is an NN source model then there are no z's and so no q^{old} (f,z,s), but the method may still need to track some past state of the NN. For example, if the NN model used is an RNN/LSTM, then one would keep the most recent value of its internal state variables before the current block.

Running the streaming NTF method involves running the iterations of steps similar to those described for stage 420, with slight modifications, for some (e.g. predetermined) number of iterations, then computing a mask for the time frame(s) corresponding to the portion of the block chosen in the hyperparameter selection phase. In an embodiment, the mask is computed in a manner similar to that described in step 430, and then steps analogous to steps 440 and 450 are implemented to produce the corresponding portion of separated sound. Then the block will advance and the process continues.

Steps of the streaming NTF method are now described in greater detail. In other embodiments, these steps may be performed in different order.

In step (1), streaming versions of X(f,n) and D(f,n) are computed as in the batch version (the definitions provide a natural streaming method to compute X and D), but now each time frame of these quantities is passed into the source separation step as the time frame becomes available. When the method is started, a number of time frames equal to the block size needs to be accumulated before later steps can continue.

Step (2) could be referred to as the main iteration loop where steps (a) and (b) are iterated. In step (a), steps 422 and 424 happen as in batch mode, but applied to the current block. In step (b), steps 426 and 428 happen in a slightly modified version as specified in the three streaming updates equations provided above. The last two of these three equations describe the streaming version of the NMF source model, in which the difference is the added q^{old} terms. If an NN source model is used, these updates would change to the corresponding description for FIG. 4 about running the current source estimate through the NN, just as in the batch case for the NN NTF but only on the current block. In cases where the NN model keeps history (e.g. RNN or LSTM), the analog of the q^{old} terms would be to run the NN model with the appropriate initial state.

In step (3), masks for each source of interest are computed. This may be done similar to step 430 described above, except only performed for the frame(s) of the block chosen when hyperparameters were set up.

In step (4), masks for each source of interest are applied and in step (5) the inverse STFT is applied to output the separated time domain audio signals. These steps are performed similar to steps 440 and 450 described above, but, again, only performed on the frame(s) chosen when hyperparameters were set up. One difference here is that the forward STFT is computed by applying the FFT to the overlapping blocks, so the inverse STFT is computed by applying the inverse FFT to the frames and then adding the resulting blocks in an overlapping fashion. Such “overlap and add” (OLA) methods are known to people skilled in the art and, therefore, are not described in detail. However, this becomes slightly subtle in the streaming case because in some implementations it is better to buffer some of the time domain audio instead directly outputting it, so at future steps overlapping blocks from other frames can be added to it. In an embodiment, only after all the blocks which must overlap to produce a particular time sample have been processed is that time sample actually streamed out.

In step (6), history of the NTF processing may be updated. Preferably, in an embodiment, this step is executed before going back to step (1) to stream more data through. In this step, the q^{old} values may be updated in accordance with the two equations for q^{old} described above, then the oldest time frame in the block may be discarded to make room for the new one computed in step (1). The second equation for q^{old} provided above applies specifically to the NMF source model. Again, if using an NN model, step (6) may instead include storing some state information regarding the previous running of the NN model.

In the case of the NMF source model, the portion of q(n|s,z) corresponding to the oldest time frame in the block may be discarded as that time frame itself is discarded. A new frame of q(n|s,z) is initialized for the new time frame. Such initialization may be carried out in any way that is efficient for a particular implementation. The exact manner of initialization is not important since the result will be refined through iterating step (2) described above. In an embodiment, this stage of the method may further include softening other parameters which can be improved through iteration, such as q(d,s), so as to allow the method to more easily adapt if the character of the data streaming changes midway through the stream. In various embodiments, such softening may be done in a variety of ways, such as e.g. adding a constant to all values and renormalizing.

It should be noted that the probabilistic interpretation used in batch mode breaks down slightly in streaming mode because, by assumption, the streaming mode method does not have the information available to normalize over all time. To handle this, one embodiment of the streaming NTF may leave some parameters un-normalized, with their sums indicating the total mass of input data which has contributed to that quantity. For example, it is possible to not normalize X(f,n) over time, but maintain the invariant that q^{old} (d,s) and q^{old} (f,z,s) each always sum to the sum of X(f,n) over all frequencies and time frames before the current block. That way the current block and past before the current block are weighted appropriately relative to each other in equations for the streaming NTF provided above.

Some implementations multiply the q^{old} values by a discount factor between 0 and 1, such as 0.9, each time they are calculated. While this may break the invariant mentioned above, it also has the effect of forgetting some of the past and being more adaptable to changing circumstances.

The streaming NTF method described herein allows many variations in implementation depending on the setting, which would not materially affect performance or which trade one desirable characteristic off in favor of another. Some of these have been mentioned above. Other variations include e.g. using a block size that is variable. In particular, depending on how data becomes available, some embodiments of the streaming NTF method may be configured to add multiple frames to the present block at one time and iterate on these as a group. This could be particularly useful in e.g. a cloud setting where the data may be coming from one machine to another in packets which may arrive out of order. If some data has arrived early, the streaming NTF method may be configured to process it early in order to save time later. Another variation includes using a variable number of iterations per block. This may be beneficial e.g. for varying separation quality based on system load.

One special case could be when a stream terminates: then a mask is computed for all frames through the end of the stream, rather than for only those frames selected in the hyperparameter selection stage. In various embodiments, these could all be computed simultaneously, or zero inputs could be streamed through the system to get it to finish up automatically without treating the end of the stream as a special case.

The streaming method presented above is flexible to easily incorporate all such variations and others.

### Cloud-Based Source Separation Services

An aspect of the present disclosure relates to apparatus, systems, and methods for providing a cloud-based blind source separation service. A computing device can partition the source separation process into a plurality of processing steps, and may identify one or more of the processing steps for execution locally by the device and one or more of the processing steps for execution remotely by one or more servers. This allows the computing device to determine how best to partition the source separation processing based both on the local resources available, the present condition of the network connection between the local and remote resources, and/or other factors relevant to the processing. Such a source separation process may include processing steps of any of the BSS methods described herein, e.g. NMF, basic NTF, NN NTF, basic NTF with NN redux, NN NTF with NN redux, streaming NTF, or any combination thereof. The source separation process may further include one or more processing steps that are uniquely suited to cloud computing, such as pattern matching to a large adaptive data set.

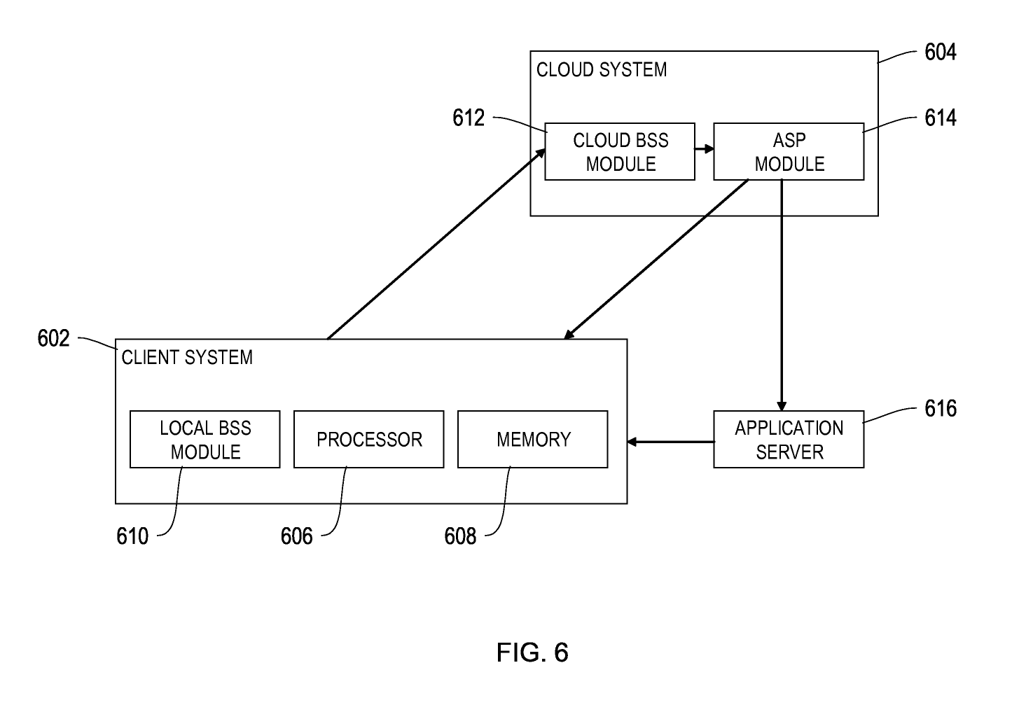

FIG. 6 illustrates a cloud-based blind source separation system in accordance with some embodiments. FIG. 6 includes a client 602 and a cloud system 604 in communication with the client 602. The client device 110 described above may be implemented as such a client 602, while the server 150 described above may be implemented as such a cloud system 604. Therefore, all of the discussions of the client 602 and the cloud system 604 are applicable to the client device 110 and the server 150 and vice versa.

The client 602 includes a processor 606, a memory device 608, and a local blind source separation (BSS) module 610. The cloud system 604 includes a cloud BSS module 612 and an acoustic signal processing (ASP) module 614. The client 602 and the cloud system 604 communicate via a communication network (not shown).

The client 602 can receive an acoustic signal that includes a plurality of audio streams, each of which originated from a distinct acoustic source. For example, a first one of the audio streams is a voice signal from a first person and a second one of the audio streams is a voice signal from a second person. As another example, a first one of the audio streams is a voice signal from a first person and a second one of the audio streams is ambient noise. It may be desirable to separate out the acoustic signal into distinct audio streams based on the acoustic sources from which the audio streams originated.

The cloud based BSS mechanism, which includes the local BSS module 610 and the cloud BSS module 612, can allow the client 602 and the cloud system 604 to distribute the processing required to separate out an acoustic signal into separated audio streams. In some embodiments, the client 602 is configured to perform BSS locally to separate out an acoustic signal into source separated audio streams at the local BSS module 610, and the client 602 can provide the source separated audio streams to the cloud system 604. In some embodiments, the client 602 is configured to send an unprocessed acoustic signal to the cloud system 604 so that the cloud system 604 can use the cloud BSS module 612 to separate out the unprocessed acoustic signal into source separated audio streams.

In some embodiments, the client 602 is configured to pre-process the acoustic signal locally at the local BSS module 610, and to provide the pre-processed acoustic signal to the cloud system 604. The cloud system 604 can subsequently perform BSS based on the pre-processed acoustic signal to provide source separated audio streams. This can allow the client 602 and the cloud system 604 to distribute memory usage, computation power, power consumption, energy consumption, and/or other processing resources between the client 602 and the cloud system 604.

For example, the local BSS module 610 can be configured to pre-process the acoustic signal to reduce the noise in the acoustic signal, and provide the de-noised acoustic signal to the cloud system 604 for further processing. As another example, the local BSS module 610 can be configured to compress the acoustic signal and provide the compressed acoustic signal to the cloud system 604 for further processing. As another example, the local BSS module 610 can be configured to derive features associated with the acoustic signal and provide the features to the cloud system 604 for blind source separation. The features can include, for example, the direction of arrival information, which can include the bearing and confidence information. The features can also include neural-net based features for generative models, e.g. features of NN models described above. The features can also include local estimates of grouping cues, for instance, harmonic stacks, which includes harmonically related voice bands in the time/frequency spectrum. The features can also include pitch information and formant information.

The source-separated signal may then be sent to an ASP module 614 which may for example process the signal as speech in order to determine one or more user commands. The ASP module 614 may be part of the same cloud system 604 as the cloud BSS module, as shown in FIG. 6. The ASP module 614 may use any of the data described herein as being used in cloud-based BSS processing in order to increase the quality of the signal processing. In some embodiments, the ASP module 614 is located remotely from cloud system 604 (e.g., in a different cloud than cloud system 604).

Compared to a raw, unprocessed signal, the source-separated signal may greatly increase the quality of the ASP. For example, where the ASP is speech recognition, an unprocessed signal may have an unacceptably high word error rate representing a significant proportion of words that are not correctly identified by the speech recognition algorithms. This may be due to ambient noise, additional voices, and other sounds interfering with the speech recognition. In favorable contrast, a source-separated signal may provide much clearer acoustic data of a user's voice issuing a command, and may therefore result in a significantly improved word error rate. Other acoustic sound processing may similarly benefit from BSS pre-processing.

The ASP can be configured to send processed signals back to the client system 602 for execution of the command. The processed signals can include, for example, a command. Alternatively or in addition, the processed signal may be sent to application server 616. The application server 616 can be associated with a third party, such as an advertising company, a consumer sales company, and/or the like. The application server 616 can be configured to carry out one or more instructions that would be understood by the third party. For example, where the processed signal represents a command to perform an internet search, the command may be sent to an internet search engine. As another example, where the processed signal a command to carry out commercial activity, the instructions may be sent to a particular online retailer or service-provider to provide the user with advertisements, requested products, and/or the like.

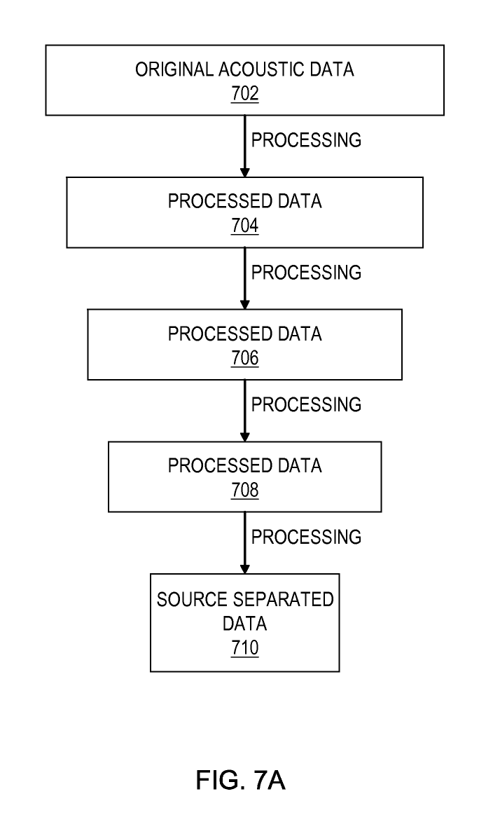

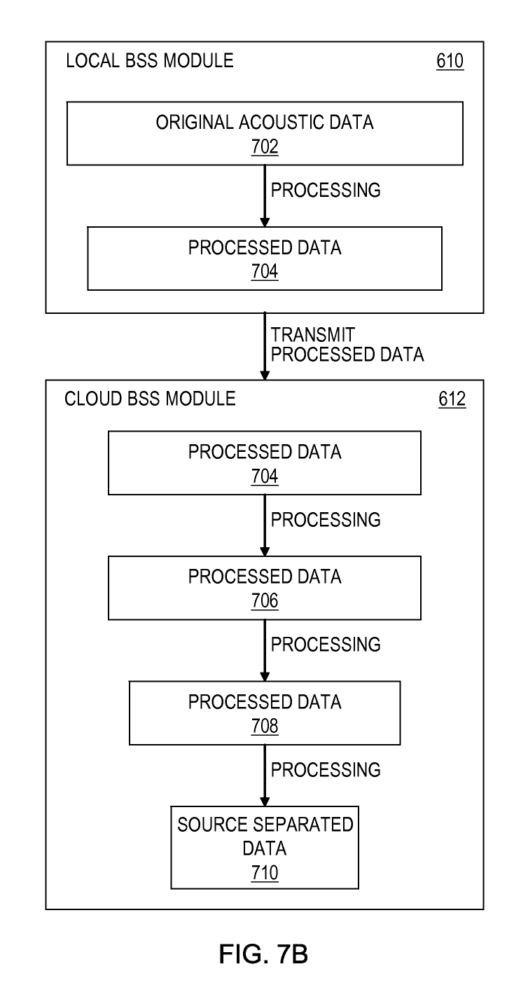

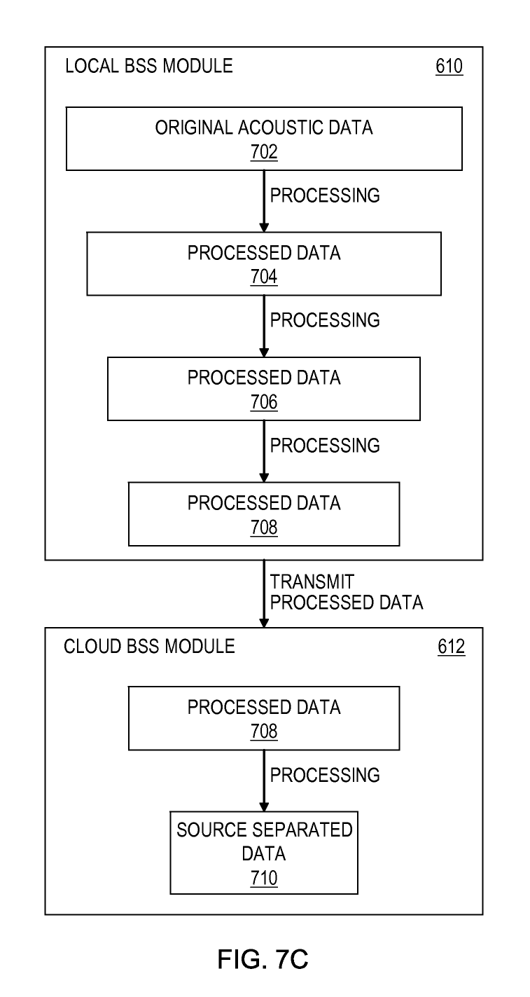

FIGS. 7A-C illustrate how blind source separation processing may be partitioned in different ways between a local client and the cloud, according to some embodiments. FIG. 7A shows a series of processing steps, each of which results in a more refined set of data. The original acoustic data 702 may undergo a first processing step to result in first intermediate processed data 704, which is further processed to result in second intermediate processed data 706, which is further processed to result in third intermediate processed data 708, which is further processed to generate source separated data 710. As illustrated, each processing step results in a more refined set of data, which in some implementations may actually represent in a smaller amount of data. The processing that results in each step of data refinement may be any process known in the art, such as noise reduction, compression, signal transformation, pattern matching, etc., many of which are described herein. In some implementations, the system may be configured to determine which processes to use in analyzing a particular recording of acoustic data based on the available resources, the circumstances of the recording, and/or the like.

As shown in FIG. 7B, in one case the system can be configured such that most of the processing is performed to the cloud BSS module 612 shown in FIG. 6. The local BSS module 610 (located at, or associated with, the local client system 602) generates processed data 704 and the client system 602 transmits processed data 704 to the cloud BSS module 612. The remaining processing shown in FIG. 7A is then performed in the cloud (e.g., resulting in processed data 706, processed data 708, and source separated data 710).

As another example, as shown in FIG. 7C, the system can be configured such that most of the processing is performed by the local BSS module 610, such that the local BSS module 610 generates processed data 708, and the client 602 transmits processed data 708 to the cloud for further processing. The cloud BSS module 612 processes the processed data 708 to generate source separated data 710.

In some implementations, the system may use any one of a number of factors to decide how much processing to allocate to the client (e.g., to local BSS module 610) and how much to allocate to the cloud (e.g., cloud BSS module 612), which can configure the amount of processing of the data transmitted to the cloud (e.g., at what point in the blind source separation processing the cloud receives data from the client). The factors may include, for example: the current state of the local client, including the available processor resources and charge; the nature of the network connection, including available bandwidth, signal strength, and stability of the connection; the conditions of the recording, including factors that may result in the use of cloud-specific processing steps as further described below; user preferences, including both explicitly stated preferences and preferences determined by the user's history and profile; preferences provided by a third party, such as an internet service provider or device vender; and/or any other relevant parameters.

The ASP module 614 can include an automatic speech recognition (ASR) module. In some embodiments, the cloud BSS module 612 and the ASP module 614 can reside in the same cloud system 604. In other embodiments, the cloud BSS module 612 and the ASP module 614 can reside in different cloud systems.

The cloud BSS module 612 can use a plurality of servers in parallel to separate out an acoustic signal into source separated streams. For example, the cloud BSS module 612 can use any appropriate distributed framework as known in the art. To give one particular example, the system could use a MapReduce mechanism for separating out an acoustic signal into source separated streams in parallel.

In the particular example of using MapReduce, in the Map phase, when the cloud BSS module 612 receives an acoustic signal (or features derived at the local BSS module 610), the cloud BSS module 612 can map one or more frames of the acoustic signal to a plurality of servers. For example, the cloud BSS module 612 can generate frames of the acoustic signal using a sliding temporal window, and map each of the frames of the acoustic signal to one of the plurality of servers in the cloud system 604.

The cloud BSS module 612 can use the plurality of servers to perform template matching in parallel. The cloud BSS module 612 can divide a database of templates into a plurality of sub-databases, and assign one of the plurality of sub-databases to one of the plurality of servers. Then, the cloud BSS module 612 can configure each of the plurality of servers to determine whether a frame of the acoustic signal assigned to itself matches any one of the templates in its sub-database. For instance, the server can determine, for each template in the sub-database, how likely it is that the frame of the acoustic signal matches the template. The likelihood of the match can be represented as a confidence.

Once the plurality of servers completes the confidence computation process, the cloud BSS module 612 can move to the reduction phase. In the reduction phase, the cloud BSS module 612 can consolidate the confidences computed by the plurality of servers to identify, for each frame of the acoustic signal, the template with the highest confidence. Subsequently, the cloud BSS module 612 can use the template to derive source separate audio streams.

In some embodiments, the cloud BSS module 612 can perform the MapReduce process in a streaming mode. For example, the cloud BSS module 612 can segment an acoustic signal into frames using a temporally sliding window, and use the frames for template matching. In other embodiments, the cloud BSS module 612 can perform the MapReduce process in a bulk mode. For example, the cloud BSS module 612 can use a global signal transformation, such as Fourier Transform or Wavelet Transform, to transform the acoustic signal to a different domain, and use frames of the acoustic signals in that new domain to perform template matching. The bulk mode MapReduce can allow the cloud BSS module 612 to take into account the global statistics associated with the acoustic signal.

In some embodiments, the cloud BSS module 612 can use data gathered from many devices to perform big-data based BSS. For example, the cloud BSS module 612 can be in communication with an acoustic signal database. The acoustic signal database can maintain a plurality of acoustic signals that can provide a priori information on acoustic signals. The cloud BSS module 612 can use the a priori information from the database to better separate audio streams from an acoustic signal.

The large database made available on the cloud may aid blind source-separation processing in a number of ways. For example, the cloud device may be able to generate a distance metric in a feature space based on an available library. Where the audio data is compared against a number of templates, the resulting confidence intervals may be taken as a probability distribution, which may be used to generate an expected value. This can, in turn, be used to generate a replacement magnitude spectrum, or instead a mask for the existing data, based on the probability distribution and the expected value. Each of these steps may be performed over a sliding window or over the entire acoustic data as appropriate.

In addition to first-order matching of a large quantity of cloud data to the acoustic data, big-data cloud BSS may also allow for further matching based on hierarchical categorization. In some embodiments, the acoustic signal database can organize the acoustic signals based on the characteristics of the acoustic signals. For example, when an acoustic signal is a voice signal from a male person, the acoustic signal can be identified as a male voice signal. The male voice signal can be further categorized into a low-pitch male voice signal, a mid-pitch male voice signal, and a high-pitch male voice signal, and categorize male voice signals accordingly. In essence, the cloud BSS module 612 can construct a hierarchical model of acoustic signals. Such a categorization of acoustic signals allow the cloud BSS module 612 to derive a priori information that are tailored to acoustic signals of particular characteristics, and to use such tailored a priori information, for example, in a topic model, to separate audio streams from an acoustic signal. In some cases, the acoustic signal database can maintain highly granular categories, in which case, the cloud BSS module 612 can maintain highly tailored a priori information, for example, a priori information associated with a particular person.

In some embodiments, the acoustic signal database can also categorize the acoustic signals based on locations at which the acoustic signals were captured. More particularly, the acoustic signal database can maintain metadata for each acoustic signal, indicating a location from which the acoustic signal was captured. For example, when the acoustic signal database receives an acoustic signal from a location corresponding to a subway station, the acoustic signal database can associate the acoustic signal to the location corresponding to the subway station. When a client 602 at that location sends a BSS request to the cloud system 604, the cloud BSS module 612 can use a priori information associated with that location to improve the BSS performance.

In some embodiments, in addition to a priori information, a cloud-based system may also be able to collect current information associated with a location. For example, if a client device is known to be in a location such as a subway station and three other client devices are also present at the same station, the data from those other client devices can be used to determine the ambient noise of the station to aid in source separation of the client's acoustic data.

In some embodiments, the acoustic signal database can also categorize the acoustic signals based on context in which the acoustic signals are captured. More particularly, the acoustic signal database can maintain metadata for each acoustic signal, indicating a context in which the acoustic signal was captured. For example, when the acoustic signal database can receive an acoustic signal from a location corresponding to a subway station, the acoustic signal database can associate the acoustic signal to the subway station. When a client 602 at a subway station sends a BSS request to the cloud system 604, the cloud BSS module 612 can use a priori information associated with a subway station, even if the client 602 is located at a different subway station, to improve the BSS performance.

In some embodiments, the cloud BSS module 612 can be configured to automatically determine a context associated with an input acoustic signal. For example, if an acoustic signal is ambiguous, the cloud BSS module 612 can be configured to determine the probability that the acoustic signal is associated with a set of contexts. The cloud BSS module 612 can weigh the a priori information associated with the set of contexts based on the probability associated with the set of contexts to improve the BSS performance.

More generally, the cloud BSS module 612 can be configured to derive a transfer function for a particular application context. The transfer function can model the multiplicative transformation of an acoustic signal, the additive transformation of the acoustic signal, and/or the like. For example, if an acoustic signal is captured in a noisy tunnel, the reverberation resulting from the tunnel can be modeled as a multiplicative transformation of an acoustic signal and the noise can be modeled as an additive transformation of the acoustic signal. In some embodiments, the transfer function can be learned using a crowd source mechanism. For example, a plurality of clients can be configured to provide acoustic signals, along with the location information of the plurality of clients, to the cloud system 604. The cloud system 604 can analyze the received acoustic signals to determine the transfer function for locations associated with the plurality of clients.

In some embodiments, the cloud BSS module 612 can be configured to use the transfer function to improve the BSS performance. For example, the cloud BSS module 612 can receive a plurality of acoustic signals associated with a tunnel. From the plurality of acoustic signals, the cloud BSS module 612 can derive a transfer function associated with the tunnel. Then, when the cloud BSS module 612 receives an acoustic signal captured from the tunnel, the cloud BSS module 612 can “undo” the transfer function associated with the tunnel (e.g., dividing the multiplicative transformation and subtracting the additive transformation) to improve the fidelity of the acoustic signal. Such a transfer function removal mechanism can provide a location-specific dictionary to the cloud BSS module 612.

In some embodiments, an acoustic profile can be constructed based on past interactions with the same local client. For example, certain client devices may be repeatedly used by the same individuals in the same locations. Over time, the system can construct a profile based on previously-collected data from a given device in order to more accurately perform source separation on acoustic data from that device. The profile may include known acoustics for a room or other area, known ambient noise such as household appliances and pets, voice profiles for recognized users, and/or the like. The system can automatically construct a transformation function for the room, filter out the known ambient noise, and better separate out the known voice based on its identified characteristics.

Furthermore, in addition to using data specific to an individual, profile-matching can allow for the construction of hierarchical models based on data from individuals other than the user of a particular local client. For example, a system may be able to apply an existing user's acoustic profile to other users with demographic or geographic similarities to the user.

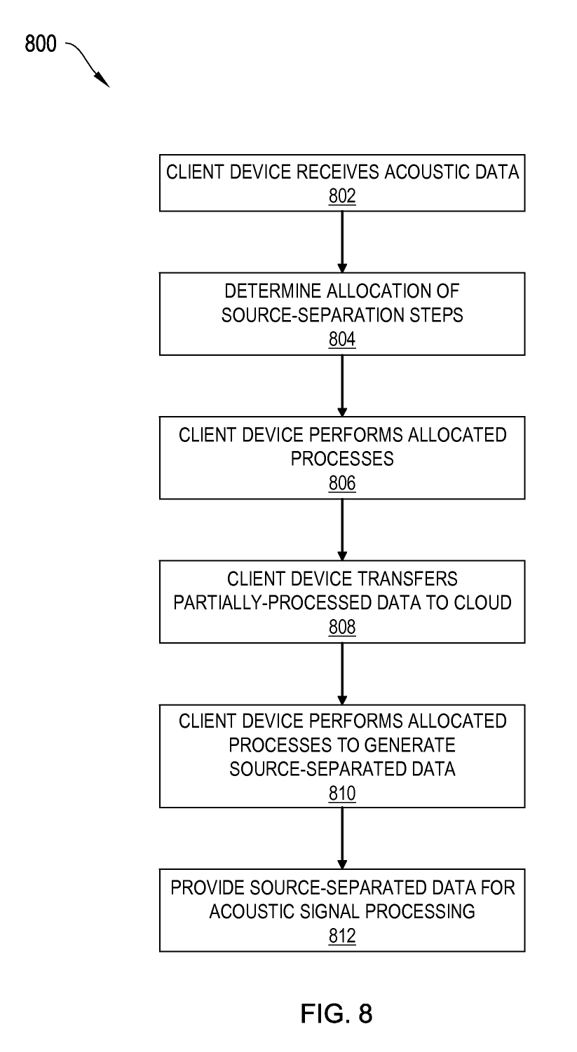

FIG. 8 is a flowchart describing an exemplary method 800 in accordance with the present disclosure. The steps of the flowchart 800 may be performed by one or more processors, such as e.g. processors or processing units within client devices 110 and 602 and/or processors or processing units within servers 150 and 604 described herein. However, any system configured to perform the methods steps illustrated in FIG. 8 is within the scope of the present disclosure. Furthermore, although the elements are shown in a particular order, it will be understood that particular processing steps may be performed by different computing devices in parallel or in a different order than that shown in the FIGURE.

A client device receives acoustic data (802). In some embodiments, the client device may be associated with an entertainment center such as a television or computer monitor; in some embodiments, the client device may be a mobile device such as a smart phone or tablet computer. The client device may receive the acoustic data following some cue provided by a user that the user will issue a command, such as pressing a particular button, using a particular gesture, or using a particular key word. Although the sound data processing capabilities described herein may be used in many other contexts, the example explicitly described herein concerns interpreting data that includes a user's speech to determine a command issued by the user.

In response to receiving the acoustic data, the system, which includes both a local device and a cloud device, determines what processing will be performed on the acoustic data in order to carry out source separation. The system then allocates each of the processing steps to either the client device or the cloud (804). In some implementations, this involves determining a sequence of processing steps and deciding at what point in the sequence to transfer the data from the client to the cloud, as discussed above. The allocation may depend on the resources available locally on the client device, as well as any added value that the cloud may provide in particular aspects of the analysis.

Although this step is described as being carried out prior to the beginning of source-separation processing, in some implementations the evaluation may be ongoing. That is, rather than predetermining at what point in the process the client device will transfer the data, the client device may perform each processing step and then evaluate whether to transfer the data before beginning the next processing step. In this way, the outcome of particular processing may be taken into account when determining to transfer data to the cloud.

The client device carries out partial source-selection processing on the received acoustic data (806). This may involve any processing step appropriate for the client device; for example, if the client device has additional information relevant to the acoustic data, such as directional data from multiple microphones, the client device may perform processing steps using this additional information. Other steps, such as noise reduction, compression, or feature identification, may also be performed by the client device as allocated.

Once the client device has carried out its part of the source-selection processing, it transfers the partially-processed data to the cloud (808). The format of the transferred data may differ depending on the stage of processing, and in addition to sending the data, the client device may provide context for the data or even instructions as to how the data should be treated.

The cloud device completes the BSS processing and generates source-separated data (810). As described above, the BSS processing steps performed by the cloud may include more and different capabilities than those available on a client device. For instance, distributed computing may allow large, parallel processing of the data to separate sources faster and with greater fidelity than a single processor. Additional data, in the form of user profiles and/or sample sounds, may also allow the cloud device to perform pattern matching and even hierarchical modeling to increase the accuracy of source separation.

The resulting source-separated acoustic data is provided for acoustic signal processing (812). This step may be performed by a third party. This step may include automated speech recognition in order to determine commands.

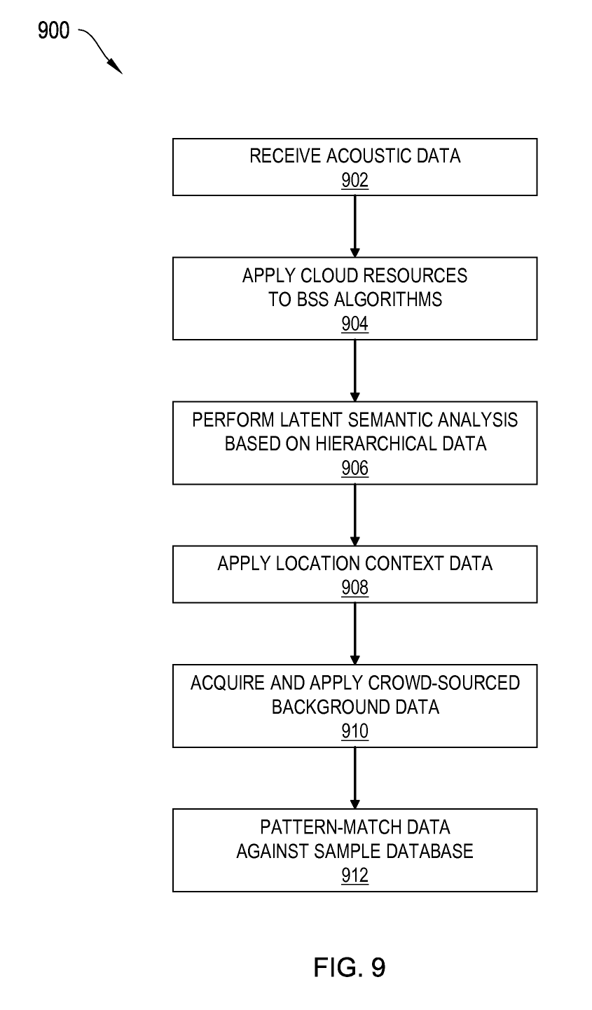

FIG. 9 is a flowchart representing an exemplary method 900 for cloud based source separation in accordance with the present disclosure. The steps of the flowchart 900 may be performed by one or more processors, such as e.g. processors or processing units within client devices 110 and 602 and/or processors or processing units within servers 150 and 604 described herein. However, any system configured to perform the methods steps illustrated in FIG. 9 is within the scope of the present disclosure. Furthermore, although the elements are shown in a particular order, it will be understood that particular processing steps may be performed by different computing devices in parallel or in a different order than that shown in the FIGURE.

Each of the steps 904-912 represent a process in which data stored in the cloud may be applied to facilitate source-separation processing for received acoustic data (902). In some implementations, the data that is uploaded to the cloud system may be unprocessed; that is, the client device may not perform any source-separation processing before transferring the data to the cloud. Alternatively, the client may perform some source-separation processing and may transfer the partially-processed data to the cloud.

The cloud system may apply cloud resources to blind source-separation algorithms in order to increase the available processing power and increase the efficiency of those algorithms (904). For example, cloud resources may allow a direction of arrival calculation, including bearing and confidence intervals, when such calculations would otherwise be too resource-intensive for timely resolution on the client device. Other resource-intensive blind source-separation algorithms that are generally not considered appropriate for real-time calculation may also be applied when the considerable resources of a cloud computing system are available. The use of distributed processing and other cloud-specific data processing techniques may be applied to any appropriate algorithm in order to increase the accuracy and precision of the results in accordance with the resources available.

Based on hierarchical data, which may include user profile information as well as preliminary pattern-matching, the system performs latent semantic analysis on the acoustic data (906). As described above, the hierarchical data may allow the system to place different components of the acoustic data in accordance with identified categories of various sounds.

The system applies contextual information related to the context of the acoustic data (908). This may include acoustic or ambient information about the particular area where the client device is, or even the type of area (such as a subway station in the example above). In some implementations, the contextual information may provide sufficient information about the reverb and other acoustic elements to apply a transform to the acoustic data.

The system acquires background data from other users that are in the same or similar locations (910). These other users essentially provide secondary microphones that can be used to cancel background noise and determine acoustic information about the client device's location.

Unlike the relatively limited storage capacity of most client devices, the cloud may potentially include many thousands of samples of audio data, and may compare this database against received acoustic data in order to identify particular acoustic sources and better separate them (912).

Any one or combination of these processes, using the cloud's greatly extended resources, may greatly facilitate source-separation and provide a greater degree of accuracy than is possible with a client device's local resources.

### Variations and Implementations

While embodiments of the present disclosure were described above with references to exemplary implementations as shown in FIGS. 1-9, a person skilled in the art will realize that the various teachings described above are applicable to a large variety of other implementations. For example, the implementation of the embodiments of the present disclosure is not limited to performing source separation on acoustic signals, but could be applied to any mixed signals, such as e.g. mixed electromagnetic signals. Furthermore, discussions provided above for the NN models are equally applicable to any other models, e.g. other regression analysis models, configured to predict magnitude spectrograms of clean speech given magnitude spectrograms of speech with background noise and/or artifacts of the types typically introduced by NTF, all of which are within the scope of the present disclosure.

In certain contexts, the features discussed herein can be applicable to automotive systems, medical systems, scientific instrumentation, wireless and wired communications, radar, industrial process control, audio and video equipment, current sensing, instrumentation (which can be highly precise), and other digital-processing-based systems.

Moreover, certain embodiments discussed above can be provisioned in digital signal processing technologies for medical imaging, patient monitoring, medical instrumentation, and home healthcare. This could include pulmonary monitors, accelerometers, heart rate monitors, pacemakers, etc. Other applications can involve automotive technologies for safety systems (e.g., stability control systems, driver assistance systems, braking systems, infotainment and interior applications of any kind).

In yet other example scenarios, the teachings of the present disclosure can be applicable in the industrial markets that include process control systems that help drive productivity, energy efficiency, and reliability. In consumer applications, the teachings of the signal processing circuits discussed above can be used for image processing, auto focus, and image stabilization (e.g., for digital still cameras, camcorders, etc.). Other consumer applications can include audio and video processors for home theater systems, DVD recorders, and high-definition televisions.

In the discussions of the embodiments above, components of a system, such as e.g. clocks, multiplexers, buffers, and/or other components can readily be replaced, substituted, or otherwise modified in order to accommodate particular circuitry needs. Moreover, it should be noted that the use of complementary electronic devices, hardware, software, etc. offer an equally viable option for implementing the teachings of the present disclosure.

Parts of various systems for performing source separation can include electronic circuitry to perform the functions described herein. In some cases, one or more parts of the system can be provided by a processor specially configured for carrying out the functions described herein. For instance, the processor may include one or more application specific components, or may include programmable logic gates which are configured to carry out the functions describe herein. The circuitry can operate in analog domain, digital domain, or in a mixed signal domain. In some instances, the processor may be configured to carrying out the functions described herein by executing one or more instructions stored on a non-transitory computer readable storage medium.

In one example embodiment, any number of electrical circuits of FIGS. 1 and 6 may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

In another example embodiment, the electrical circuits of FIGS. 1 and 6 may be implemented as stand-alone modules (e.g., a device with associated components and circuitry configured to perform a specific application or function) or implemented as plug-in modules into application specific hardware of electronic devices. Note that particular embodiments of the present disclosure may be readily included in a system on chip (SOC) package, either in part, or in whole. An SOC represents an IC that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the functionalities of source separation methods described herein may be implemented in one or more silicon cores in Application Specific Integrated Circuits (ASICs), Field Programmable Gate Arrays (FPGAs), and other semiconductor chips.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of FIGS. 1-9 may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of FIGS. 1 and 6 and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

It is also important to note that the functions related to source separation methods described herein illustrate only some of the possible functions that may be executed by, or within, system illustrated in FIGS. 1 and 6. Some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

Note that all optional features of the apparatus described above may also be implemented with respect to the method or process described herein and specifics in the examples may be used anywhere in one or more embodiments.

1. A method for processing at least one signal acquired using an acoustic sensor, the at least one signal having contributions from a plurality of acoustic sources, the method comprising using one or more processors performing steps of:
accessing an indication of a current block size, the current block size defining a size of a portion of the at least one signal to be analyzed to separate from the at least one signal one or more contributions from a first acoustic source of the plurality of acoustic sources;
analyzing a first portion of the at least one signal, the first portion being of the current block size, by:
computing one or more first characteristics from data of the first portion, and
using the computed one or more first characteristics, or derivatives thereof, in performing iterations of a nonnegative tensor factorization (NTF) model for the plurality of acoustic sources for the data of the first portion to separate, from at least the first portion of the at least one acquired signal, one or more first contributions from the first acoustic source; and
analyzing a second portion of the at least one signal, the second portion being of the current block size and being temporaly shifted with respect to the first portion, by:
computing one or more second characteristics from data of the second portion, and
using the computed one or more second characteristics, or derivatives thereof, in performing iterations of the NTF model for the data of the second portion to separate, from at least the second portion of the at least one acquired signal, one or more second contributions from the first acoustic source.

2. The method according to claim 1, wherein accessing the indication of the current block size comprises receiving user input providing the indication of the current block size or a derivative thereof.

3. The method according to claim 1, wherein accessing the indication of the current block size comprises computing the current block size based on one or more factors.

4. The method according to claim 1, wherein the first portion and the second portion overlap in time.

5-73. (canceled)

74. A method for processing at least one signal acquired using a corresponding acoustic sensor, the signal having contributions from a plurality of different acoustic sources, the method comprising using one or more processors performing steps of steps of:
computing time-dependent spectral characteristics from the at least one acquired signal, the spectral characteristics comprising a plurality of components;
applying a neural network model to the time-dependent spectral characteristics, the neural network model configured to compute property estimates of a property, each component of a first subset of the components having a corresponding one or more property estimates of the property;
performing iterations of a nonnegative tensor factorization (NTF) model for the plurality of acoustic sources, the iterations comprising (a) combining values of a plurality of parameters of the NTF model with the computed property estimates to separate from the at least one acquired signal one or more contributions from a first acoustic source of the plurality of acoustic sources.

75. The method according to claim 74, wherein performing iterations comprises:
(a) combining values of the plurality of parameters of the NTF model with the computed property estimates to generate, using the NTF model, for each acoustic source of the plurality of acoustic sources, a spectrogram of the acoustic source,
(b) for each acoustic source of the plurality of acoustic sources, scaling a portion of the spectrogram of the acoustic source corresponding to each component of a second subset of the plurality of components by a corresponding scaling factor to generate a scaled spectrogram of the acoustic source, and
(c) updating values of at least some of the plurality of parameters based on the scaled spectrograms of the plurality of acoustic sources.

76. The method according to claim 74, further comprising:
using the values of the plurality of parameters of the NTF model following completion of the iterations to generate a mask for identifying the one or more contributions from the first acoustic source to the time-dependent spectral characteristics; and
applying the generated mask to the time-dependent spectral characteristics to separate the one or more contributions from the first acoustic source.

77-85. (canceled)

86. A method for processing at least one signal acquired using a corresponding acoustic sensor, the signal having contributions from a plurality of different acoustic sources, the method comprising using one or more processors performing steps of steps of:
computing time-dependent spectral characteristics from the at least one acquired signal, the spectral characteristics comprising a plurality of components;
accessing at least a first model configured to predict contributions from a first acoustic source of the plurality of acoustic sources; and
performing iterations of a nonnegative tensor factorization (NTF) model for the plurality of acoustic sources, the iterations comprising running the first model to separate from the at least one acquired signal one or more contributions from the first acoustic source.

87. The method according to claim 86, wherein performing iterations comprises:
(a) combining values of the plurality of parameters of the NTF model to generate, using the NTF model, for each acoustic source of the plurality of acoustic sources, a spectrogram of the acoustic source;
(b) for each acoustic source of the plurality of acoustic sources, scaling a portion of the spectrogram of the acoustic source corresponding to each component of a first subset of the plurality of components by a corresponding scaling factor to generate a scaled spectrogram of the acoustic source; and
(c) running the first model using at least a portion of the scaled spectrogram as an input to the first model to update values of at least some of the plurality of parameters.

88. The method according to claim 86, further comprising:
using the values of the plurality of parameters of the NTF model following completion of the iterations to generate a mask for identifying the one or more contributions from the first acoustic source to the time-dependent spectral characteristics; and
applying the generated mask to the time-dependent spectral characteristics to separate the one or more contributions from the first acoustic source.

89-134. (canceled)

135. A system for processing at least one signal acquired using an acoustic sensor, the at least one signal having contributions from a plurality of acoustic sources, the system comprising:
at least one memory configured to store computer executable instructions; and
at least one processor coupled to or comprising the at least one memory and configured, when executing the instructions, to carry out a method comprising:
accessing an indication of a current block size, the current block size defining a size of a portion of the at least one signal to be analyzed to separate from the at least one signal one or more contributions from a first acoustic source of the plurality of acoustic sources;
analyzing a first portion of the at least one signal, the first portion being of the current block size, by:
computing one or more first characteristics from data of the first portion, and
using the computed one or more first characteristics, or derivatives thereof, in performing iterations of a nonnegative tensor factorization (NTF) model for the plurality of acoustic sources for the data of the first portion to separate, from at least the first portion of the at least one acquired signal, one or more first contributions from the first acoustic source; and
analyzing a second portion of the at least one signal, the second portion being of the current block size and being temporaly shifted with respect to the first portion, by:
computing one or more second characteristics from data of the second portion, and
using the computed one or more second characteristics, or derivatives thereof, in performing iterations of the NTF model for the data of the second portion to separate, from at least the second portion of the at least one acquired signal, one or more second contributions from the first acoustic source.

136. The system according to claim 135, further comprising the acoustic sensor.

137. The system according to claim 135, wherein the system is integrated in a client device or in a server, the server communicatively connected to the client device.

138-142. (canceled)

143. The method according to claim 1, further comprising applying one or more past statistics computed from data of a past portion of the at least one signal in performing the iterations of the NTF model for the data of the first portion and/or for the data of the second portion,
wherein the past portion comprises a portion of the at least one signal that has been analyzed to separate from the at least one signal one or more contributions from the first acoustic source.

144. The method according to claim 143, wherein:
the past portion comprises a plurality of portions of the at least one signal, each portion of the plurality of portions being of the current block size, and
the one or more past statistics from the data of the past portion comprise a combination of one or more characteristics computed from data of each portion of the plurality of portions and/or results of performing iterations of the NTF model for the data of the each portion.

145. The method according to claim 144, wherein the plurality of portions overlap in time.

146. The method according to claim 1, wherein at least one further signal is acquired using a corresponding further acoustic sensor and wherein analyzing each respective portion of the first portion and the second portion comprises:
computing the one or more characteristics of the respective portion by:
computing respective time-dependent spectral characteristics from the respective portion of the at least one signal, the respective spectral characteristics comprising a plurality of respective components, and
computing respective direction estimates from the at least one signal and the at least one further signal, each component of a first subset of the plurality of respective components having a corresponding one or more of the respective direction estimates, and
using the computed one or more characteristics, or the derivatives thereof, of the respective portion in performing iterations of the NTF model for the data of the respective portion by performing iterations comprising (a) combining respective values of a plurality of parameters of the NTF model with the computed respective direction estimates.

147. The method according to claim 146, wherein performing iterations comprises:
(a) combining the respective values of the plurality of parameters of the NTF model with the computed respective direction estimates to generate, using the NTF model, for each acoustic source of the plurality of acoustic sources, a spectrogram of the acoustic source,
(b) for each acoustic source of the plurality of acoustic sources, scaling a portion of the spectrogram of the acoustic source corresponding to each component of a second subset of the plurality of components by a corresponding scaling factor to generate a scaled spectrogram of the acoustic source, and
(c) updating respective values of at least some of the plurality of parameters based on the scaled spectrograms of the plurality of acoustic sources.

148. The method according to claim 146, wherein the plurality of parameters comprise a direction distribution parameter q(d|s) indicating, for each acoustic source of the plurality of acoustic sources, probability that the acoustic source comprises one or more contributions in each of a plurality of the computed respective direction estimates.

149. The method according to claim 146, further comprising:
combining the computed respective spectral characteristics with the computed respective direction estimates to form a respective data structure representing a distribution indexed by time, frequency, and direction, and
performing the NTF using the formed respective data structure.
